(19) United States
(12) Patent Application Publication
(10) Pub. No.: US 2023/0350814 A1
(43) Pub. Date: Nov. 2, 2023

(54) DEVICE, METHOD AND SYSTEM TO SUPPLEMENT A CACHE WITH A RANDOMIZED VICTIM CACHE

(71) Applicant: Intel Corporation, Santa Clara, CA (US)

(72) Inventors: Thomas Unterluggauer, Villach (AT); Fangfei Liu, Hillsboro, OR (US); Carlos Rozas, Portland, OR (US); Scott Constable, Portland, OR (US); Gilles Pokam, Livermore, CA (US); Francis McKeen, Portland, OR (US); Christopher Wilkerson, Portland, OR (US); Erik Hallnor, Beaverton, OR (US)

(73) Assignee: Intel Corporation, Santa Clara, CA (US)

(21) Appl. No.: 18/078,762

(22) Filed: Dec. 9, 2022

Related U.S. Application Data
(60) Provisional application No. 63/335,671, filed on Apr. 27, 2022.

(51) Int. Cl. G06F 12/14; G06F 12/0815; G06F 12/121

(52) U.S. Cl. CPC G06F 12/1408; G06F 12/0815; G06F 12/121; G06F 2212/1052

(57) ABSTRACT

Techniques and mechanisms for a victim cache to operate in conjunction with another cache to help mitigate the risk of a side-channel attack. In an embodiment, a first line is evicted from a primary cache, and moved to a victim cache, based on a message indicating that a second line is to be stored to the primary cache. The victim cache is accessed using an independently randomized mapping. Subsequently, a request to access the first line results in a search of the victim cache and the primary cache. Based on the search, the first line is evicted from the victim cache, and reinserted in the primary cache. In another embodiment, reinsertion of the first line in the primary cache includes the first line and a third line being swapped between the primary cache and the victim cache.

### CLAIM OF PRIORITY

The present application claims priority under 35 U.S.C. § 119(e) to U.S. Provisional Patent Application Ser. No. 63/335,671 filed Apr. 27, 2022 and entitled “DEVICE, METHOD AND SYSTEM TO SUPPLEMENT A CACHE WITH A RANDOMIZED VICTIM CACHE,” which is herein incorporated by reference in its entirety.

### BACKGROUND

### 1. Technical Field

This disclosure generally relates to cache memory systems and more particularly, but not exclusively, to the use of a victim cache to provide protection from side-channel attacks.

### 2. Background Art

In a processor-based system, a cache memory is used to temporarily store information including data or instructions to enable more rapid access by processing elements of the system such as one or more processors, graphics devices and so forth. Modern processors include internal cache memories that act as repositories for frequently used and recently used information. Because this cache memory is within a processor package and typically on a single semiconductor die with one or more cores of the processor, much more rapid access is possible than from more remote locations of a memory hierarchy, which include system memory.

To enable maintaining the most relevant information within a cache, some type of replacement mechanism is used. Many systems implement a type of least recently used algorithm to maintain information. More specifically, each line of a cache is associated with metadata information relating to the relative age of the information such that when a cache line is to be replaced, an appropriate line for eviction can be determined.

Over the years, caches have become a source of information leakage that are exposed to “side-channel” attacks whereby a malicious agent is able to infer sensitive data (e.g., cryptographic keys) that is processed by a victim software process. Typically, cache-based side-channel attacks, which exploit cache-induced timing differences of memory accesses, are used to break Advanced Encryption Standard (AES), Rivest—Shamir—Adleman (RSA) or other cryptographic protections, to bypass address-space layout randomization (ASLR), or to otherwise access critical information. As the number and variety of side-channel attacks continue to increase, there is expected to be an increasing demand placed on improved protections to cache memory systems.

### BRIEF DESCRIPTION OF THE DRAWINGS

The various embodiments of the present invention are illustrated by way of example, and not by way of limitation, in the figures of the accompanying drawings and in which:

FIG. 1 illustrates a functional block diagram showing features of a system to provide protections for cache resources according to an embodiment.

FIG. 2 illustrates a flow diagram showing features of a method to operate cache memory resources according to an embodiment.

FIG. 3 illustrates a functional block diagram showing features of a system to move a line between caches according to an embodiment.

FIG. 4 illustrates a flow diagram showing features of a method to service a data access request according to an embodiment.

FIG. 5 illustrates a flow diagram showing features of a method to process a cache hit according to an embodiment.

FIG. 6 illustrates a flow diagram showing features of a method to process a cache miss according to an embodiment.

FIG. 7 illustrates an exemplary system.

FIG. 8 illustrates a block diagram of an example processor that may have more than one core and an integrated memory controller.

FIG. 9A is a block diagram illustrating both an exemplary in-order pipeline and an exemplary register renaming, out-of-order issue/execution pipeline according to examples.

FIG. 9B is a block diagram illustrating both an exemplary example of an in-order architecture core and an exemplary register renaming, out-of-order issue/execution architecture core to be included in a processor according to examples.

FIG. 10 illustrates examples of execution unit(s) circuitry.

FIG. 11 is a block diagram of a register architecture according to some examples.

FIG. 12 illustrates examples of an instruction format.

FIG. 13 illustrates examples of an addressing field.

FIG. 14 illustrates examples of a first prefix.

FIGS. 15A-D illustrate examples of how the R, X, and B fields of the first prefix in FIG. 14 are used.

FIGS. 16A-B illustrate examples of a second prefix.

FIG. 17 illustrates examples of a third prefix.

FIG. 18 is a block diagram illustrating the use of a software instruction converter to convert binary instructions in a source instruction set architecture to binary instructions in a target instruction set architecture according to examples.

### DETAILED DESCRIPTION

Embodiments discussed herein variously provide techniques and mechanisms for a victim cache to operate in conjunction with another cache to help mitigate the risk of a side-channel attack. Certain features of various embodiments are described herein with reference to the provisioning of a victim cache in support of another cache (which is referred to herein as a “primary” cache). However, other embodiments similarly incorporate a similar use of a victim resource in support of a corresponding primary resource of a same resource type. For example, other embodiments variously provision one “victim” coherence directory in support of another “primary” coherence directory (e.g., a victim snoop filter in support of a corresponding primary snoop filter).

Embodiments described herein variously supplement operation of a primary cache with another cache (referred to herein as a “victim cache”) which is to be an at least temporary repository of a line that is evicted from the cache. Such a line is subject to being moved back (or “reinserted”) in the primary cache—e.g., in response to a request by an executing process to access the line. It is to be noted that the term “primary” is used herein in the limited context of data being inserted in such a cache as one primary (or “preliminary”) condition for said data potentially being inserted, subsequently, in a corresponding victim cache. More particularly, various embodiments are not limited as to whether or not some other cache might also have received such data prior to the primary cache.

Certain features of some embodiments are described herein with reference the use a victim cache to supplement a primary cache which operates as a shared cache of a processor. However, in alternative embodiments, such a primary cache instead operates as any of various other types of caches including, but not limited to, a lowest level (L0) cache, a L1 cache, a L2 cache, a cache which is external to a processor, or the like.

As used herein with respect to the storing of information at a cache, “line” refers to information which is to be so stored at a given location (e.g., by particular memory cells in a set) of that cache. As variously used herein, a label of the type “L_{K}” represents a given line which is addressable with a corresponding address labeled “K”—e.g., wherein a line L_{C} corresponds to an address C, a line L_{V} corresponds to an address V, a line L_{X} corresponds to an address X, a line L_{Y} corresponds to an address Y, etc.

As used herein, “skewed cache” refers to a cache which is partitioned into multiple divisions comprising respective ways (which, in turn, each comprise respective sets). In some embodiments, randomization of a victim cache is provided, for example, by the use of one or more (pseudo)random indices each for a respective set of the victim cache—e.g., wherein a cipher block or hash function generates one or more indices based on address information and a corresponding one or more key values. In some embodiments, indexing of a victim cache is regularly updated by replacing or otherwise modifying such one or more key values.

Additionally or alternatively, randomization of a primary cache (e.g., a skewed cache) is provided, for example, by the use of (pseudo)random indexing for one or more sets of the primary cache—e.g., wherein a cipher block or hash function generates indices based on address information and a corresponding one or more other key values. In some embodiments, indexing of a primary cache is regularly updated by replacing or otherwise modifying such one or more other key values.

In some embodiments, access to a randomized victim cache and/or a randomized primary cache—such as a randomized skewed cache (RSC)—is provided with encryption functionality or hashing functionality in a memory pipeline. In one such embodiment, a set of one or more keys is generated (e.g., randomly) upon a boot-up or other initialization process. Such a set of one or more keys is stored for use in determining cache indices, and (for example) is to be changed at some regular—e.g., configurable—interval.

In various embodiments, an encryption scheme (or hash function) used to calculate per-division set indices is sufficiently lightweight—as determined by implementation-specific details—to accommodate critical time constraints of cache operations. However, the encryption scheme (or hash function) is preferably strong enough, for example, to prevent malicious agents from easily finding addresses that have cache-set contention. QARMA, PRINCE, and SPECK are examples of some types of encryption schemes which are variously adaptable to facilitate generation of set indices in certain embodiments.

In various embodiments, the victim cache is implemented as a fully associative or as a set-associative cache that is to be accessed using an independently randomized mapping. In one such embodiment, the victim cache is to be searched (for example) in parallel with a search of the primary cache. In one such embodiment, the primary cache and the victim cache have substantially the same hit latency (e.g., where one such latency is within 10% of the other latency).

In an embodiment, the primary cache and/or the victim cache include (or otherwise operate based on) controller circuitry that is able to automatically access the primary cache to reinsert lines as described herein. Additionally or alternatively, arbitration circuitry is provided to arbitrate between use of the primary cache for reinsertion of lines from the victim cache, and use of the primary cache by the core.

In providing a victim cache with functionality to reinsert lines from the victim cache to a primary cache, some embodiments make it significantly more difficult for a malicious agent to observe cache contention for the primary cache. As a result, such embodiments enable a relatively large interval at which encryption keys (and/or other information for securing cache accesses) should be updated to effectively protect from contention-based cache attacks.

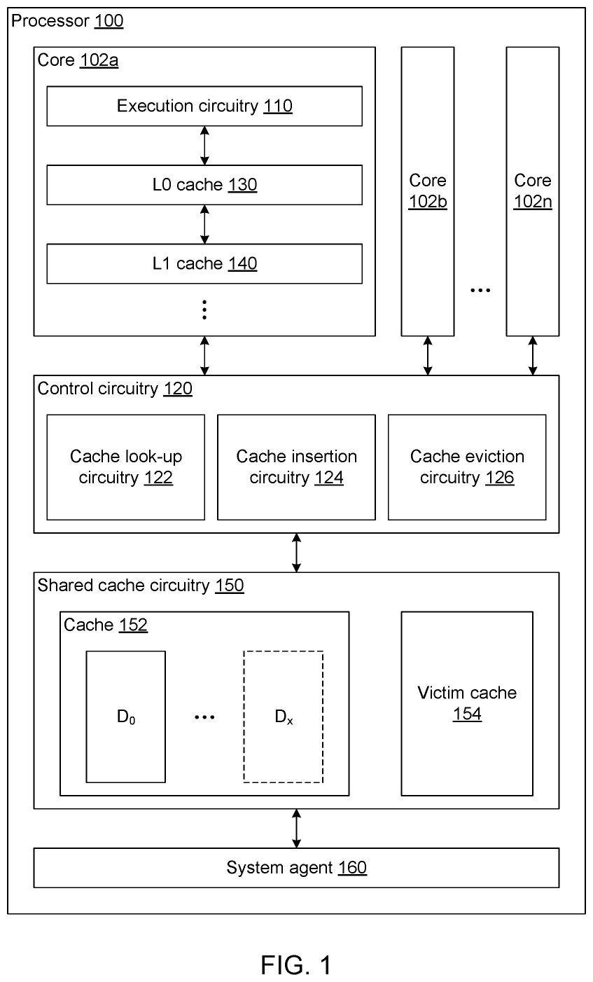

FIG. 1 shows features of a processor 100 to maintain cached data according to an embodiment. Processor 100 is one example of an embodiment wherein a randomized victim cache functions as a repository for a line which is evicted from a primary cache (such as a cache which is randomized and, in some embodiments, skewed), wherein said line is subject to being recached to the primary cache.

As shown in FIG. 1, processor 100 is a multicore processor including a plurality of cores 102a, 102b, . . . , 102n (generically core 102). Although described herein with reference to providing cache functionality with a multicore processor, some embodiments are not limited in this regard, and such embodiments apply equally to single core processors, as well as to any of a various state machines and/or other circuit components which are operable to access a cache memory. In general, each core of the processor includes execution circuitry 110 which (for example) generally takes the form of a processor pipeline including a plurality of stages including one or more front end units, one or more execution units, and one or more backend units. In different implementations, processor 100 is an in-order processor or, alternatively, an out-of-order processor.

A given core 102 supports one or more instructions sets such as the x86 instruction set (with some extensions that have been added with newer versions); the MIPS instruction set of MIPS Technologies of Sunnyvale, Calif.; the ARM instruction set (with optional additional extensions such as NEON) of ARM Holdings of Sunnyvale, Calif., a RISC-V instruction set, or the like. It should be understood that, in some embodiments, a core 102 supports multithreading—i.e., executing two or more parallel sets of operations or threads—and (for example) does so in any of a variety of ways including time sliced multithreading, simultaneous multithreading (where a single physical core provides a logical core for each of the threads that physical core is simultaneously multithreading), or a combination thereof (e.g., time sliced fetching and decoding combined with simultaneous multithreading thereafter such as in the Intel® Hyperthreading technology).

In one example embodiment, processor 100 is a general-purpose processor, such as a Core™ i3, i5, i7, 2 Duo and Quad, Xeon™, Itanium™, XScale™ or StrongARM™ processor, which are available from Intel Corporation, of Santa Clara, Calif. Alternatively, processor 100 is from another company, such as ARM Holdings, Ltd, MIPS, etc. In other embodiments, processor 100 is a special-purpose processor, such as, for example, a network or communication processor, compression engine, graphics processor, co-processor, embedded processor, or the like. In various embodiments, processor 100 is implemented on one or more chips. Alternatively, or in addition, processor 100 is a part of and/or implemented on one or more substrates using any of a number of process technologies, such as, for example, BiCMOS, CMOS, or NMOS. In some embodiments, a system on a chip (SoC) includes processor 100.

In general, execution circuitry 110 of core 102a operates to fetch instructions, decode the instructions, execute the instructions and retire the instructions. In one such embodiment, some of these instructions—e.g., including user-level instructions or privileged level instructions—are encoded to allocate data or instructions into a cache, and/or to access the cache to read said data or instructions.

Processor 100 comprises one or more levels of cache—e.g., wherein some or all of cores 102a, 102b, . . . , 102n each include a respective one or more cache levels, and (for example) wherein one or more caches of processor 100 are shared by various ones of cores 102a, 102b, . . . , 102n. In the illustrative embodiment shown, core 102a comprises a lowest level (LO) cache 130, and a next higher level of cache, namely a level 1 (L1) cache 140 which is coupled to LO cache 130. Some or all of cores 102a, 102b, . . . , 102n are each coupled to shared cache circuitry 150 that, in turn, is coupled to a system agent 160, also referred to as uncore circuitry, which can include various components of a processor such as power control circuitry, memory controller circuitry, interfaces to off-chip components and the like. Although shown at this high level in the embodiment of FIG. 1, understand the scope of the present invention is not limited in this regard.

As seen in FIG. 1, cores 102a, 102b, 102n are variously coupled to control circuitry 120 which, for example, comprises a cache controller or other control logic to control storage and retrieval operations with regard to cache circuitry, such as the illustrative shared cache circuitry 150 shown. In the example embodiment of FIG. 1, victim cache functionality is provided to promote the security of a shared (or other) cache of processor 100, as shown by shared cache circuitry 150. However, in other embodiments, victim cache functionality is additionally or alternatively used to enhance the security of a L0 cache, a L1 cache, a L2, cache, a last level cache, and/or any of various other types of caches which, for example, reside in (or alternatively, are to be coupled to) a processor.

In one example embodiment, shared cache circuitry 150 comprises memory regions to provide respective caches 152, 154—e.g., wherein cache 154 is to function as a random victim cache for cache 152. In an embodiment, control circuitry 120 and shared cache circuitry 150 operate to provide a partitioning of cache 152—e.g., where such partitioning facilitates operation of cache 152 as a skewed cache. For example, control circuitry 120 provides functionality to partition cache 152 into one or more divisions—e.g., including the illustrative divisions D₀, D₁ shown—which are each arranged into respective columns (or “ways”), which in turn each comprise respective sets. The various ways of cache 152 provide multiple respective degrees of set associativity. To help protect side-channel attacks which target cache 152, control circuitry 120 operates victim cache 154, in some embodiments, as a repository to receive lines which are evicted from cache 152. In one such embodiment, a given one of said lines is subsequently evicted from cache 154 for reinsertion into cache 152.

For example, cache look-up circuitry 122 of control circuitry 120 illustrates any of a variety of one or more of microcontrollers, application-specific integrated circuits (ASICs), state machines, programmable gate arrays, mode registers, fuses, and/or other suitable circuit resources which are configured to identify a particular location—at one of caches 152, 154—to which (or from which) a given line is to be cached, read, evicted, reinserted or otherwise accessed. In one such embodiment, cache look-up circuitry 122 performs a calculation, look-up or other operation to identify an index for the cache location—e.g., based on an address which has been identified as corresponding to a given line. For example, the index is determined based on an encryption (or hash) operation which uses the address. In some embodiments, cache look-up circuitry 122 also provides functionality to provide at least some further randomization with respect to how cache locations are each to correspond to a respective index, and/or with respect to how lines are each to be stored to a respective cache location. In one such embodiment, cache look-up circuitry 122 further supports a regular updating of indices which are to be used to access cache 152—e.g., wherein cache look-up circuitry 122 updates encryption keys or hash functions which are variously used to determine said indices. In various embodiments, cache look-up circuitry 122 performs one or more operations which, for example, are adapted from conventional techniques for partitioning, accessing or otherwise operating a cache (such as a randomized and/or skewed cache).

Cache insertion circuitry 124 of control circuitry 120 illustrates any of a variety of one or more of microcontrollers, ASICs, state machines, programmable gate arrays, mode registers, fuses, and/or other suitable circuit resources which are configured to store a given line into a location of one of caches 152, 154. For example, cache insertion circuitry 124 operates (e.g., in conjunction with cache look-up circuitry 122) to identify a location at cache 152 which is to receive a line which is to be evicted from cache 154 or, for example, a line which is retrieved from an external memory (not shown) that is to be coupled to processor 100. Alternatively or in addition, cache insertion circuitry 124 operates to identify a location at cache 154 which is to receive a line which is to be evicted from cache 152, for example. In various embodiments, cache insertion circuitry 124 performs one or more operations which are adapted from conventional techniques for storing lines to a cache.

Cache eviction circuitry 126 of control circuitry 120 illustrates any of a variety of one or more of microcontrollers, ASICs, state machines, programmable gate arrays, mode registers, fuses, and/or other suitable circuit resources which are configured to evict a line from one of caches 152, 154. For example, cache eviction circuitry 126 operates—e.g., in conjunction with cache look-up circuitry 122—to identify a location at cache 152 which stores a line to be evicted to cache 154 (or, for example, to be evicted to an external memory). Alternatively or in addition, cache eviction circuitry 126 operates to identify a location at cache 154 which stores a line to be evicted to cache 152, for example. In various embodiments, cache eviction circuitry 126 performs one or more operations which are adapted from conventional techniques for evicting lines from a cache.

In various embodiments, access to victim cache 154 also randomized—e.g., wherein victim cache 154 is a fully associative cache with w_{VC} ways, or (for example) a set-associative cache with w_{VC} ways and s_{VC} sets—i.e., with N_{VC}=(s_{VC}·w_{VC}) lines. In one such embodiment, a randomized, set-associative victim cache (similar to randomized, set-associative primary cache), uses a cryptographic function based on a block cipher E (or a hash function H) and a secret key K_{VC} to derive the victim cache's set index from the cache line address. Lines that are evicted from the primary cache are put into the victim cache. Lines that hit in the victim cache can be reinserted into the primary cache but may also stay in the victim cache without loss of security. To introduce randomness into replacement decisions, either the victim cache or the primary cache uses a randomized replacement policy. For a good performance-security trade-off, the primary cache will, in some embodiments, use a well-performing replacement algorithm like (Quad-Age/Octa-Age)-LRU, whereas the victim cache will use random replacement, for example.

In an illustrative scenario according to one embodiment, cache 152 is operated as a primary cache which comprises N=(s·w) lines (where the integer s is a number of sets, and the integer w is a number of ways). For example, the N lines are organized into d divisions by grouping together w/d ways in each division (wherein 1≤d≤w, and wherein 1≤w/d≤w). Cache 152 is skewed by such divisions—e.g., wherein indices are used to variously select corresponding sets each in a different respective one of the d division. Such indices are variously derived (for example) using a block cipher, or a keyed hash function within the memory pipeline.

However, it is to be noted that some embodiments are not limited with respect to cache 152 being a skewed cache. For example, in an alternative embodiment, cache 152 includes only one division D₀—e.g., providing an otherwise traditional set-associative cache that, in some embodiments, uses a randomized set index (e.g., derived by a cryptographic scheme using a block cipher E or a keyed hash function H).

By way of illustration and not limitation, in some embodiments, a look-up operation to access a given set of cache 152 comprises cache look-up circuitry 122 obtaining d differently encrypted (or, for example, hashed) values C_{enc,0}, C_{enc,1}, . . . , C_{enc,d-1} each based on an address C and a different respective key. In one such embodiment, for a line L_{C} of data which corresponds to the address C, d different encryptions of the address C are performed by cache look-up circuitry 122, where each such encryption is based on a block cipher E and on a different respective one of d keys K₀, K₁, . . . , K_{d-1}. Alternatively, d different hashes of the address C are calculated by cache look-up circuitry 122, each based on a hash function H and on a different respective one of the d keys K₀, K₁, . . . , K_{d-1}. Subsequently, d different indices idx₀, idx₁, . . . , idx_{d-1} are determined—e.g., by identifying, for each of the d encrypted (or hashed) address values C_{enc,0}, C_{enc1}, . . . , C_{enc,d-1}, a respective slice of log₂ s bits.

In one such embodiment, accessing cache 152 comprises cache look-up circuitry 122 performing lookups in each of d sets—e.g., in parallel with each other—to determine if a given line L_{C} corresponding to the indicated address C can be found. If line L_{C} is not found by said lookups, cache insertion circuitry 124 chooses one of the d sets (for example, at randomly) for inserting the line L_{C}. Any of a variety of replacement algorithm can be used—e.g., according to conventional cache management techniques—to store the line L_{C} within the chosen set. Typically, since a pseudorandom mapping of an address C to indices idx₀, idx₁, . . . , idx_{d-1} is at risk of being learned over time by a malicious agent, the keys K₀, K₁, . . . , K_{d-1} should be updated regularly to mitigate the risk of contention-based (or other) side-channel attacks.

Various features of processor 100 described herein help reduce the risk of side-channel attacks which target a primary cache. For example, fine-grained contention-based cache attacks exploit contention in cache sets, wherein malicious agents typically need some minimal set of addresses that map to the same cache set (a so-called eviction set) as the victim address of interest. Some types of primary caches (for example, randomized and/or skewed caches) significantly increase the complexity of finding such eviction sets, due to the use of a pseudo-random address-to-set mapping and cache skewing. Namely, addresses that collide with a victim address in all d divisions are very unlikely—i.e., with a probability in proportion to s^{-d}—forcing a malicious agent to use more likely partial collisions. Such partially conflicting addresses collide with the victim, e.g., in a single division only, but also have smaller probability to evict the victim address (or observe a victim access), i.e., d⁻² if an address collides with the victim address in a single division.

One technique for side-channel attacks to find partially conflicting addresses includes (1) priming a cache with a set of candidate attacker addresses, (2) removing candidate addresses that miss in the cache (pruning step), (3) triggering the victim to access the address of interest, and (4) probing the remaining set of candidate addresses. A candidate address missing in the cache has a conflict with the victim in at least one division. While this interactive profiling technique does not break caches entirely, it demands that keys be refreshed at relatively high rates, which impacts system performance.

To mitigate the threat and/or impact of these attacks, some embodiments variously provide a type of cache—referred to herein as a reinserting victim cache (VC) or, for brevity, simply “VC”—which is available for use, in combination with a primary cache, such as a randomized cache (RC) and, in some embodiments, a randomized skewed cache (RSC). In one such embodiment, a given line which is evicted from a primary cache is put into a VC. Subsequently, said line is reinserted into the primary cache—e.g., by swapping lines between respective entries of the the primary cache and the VC. Benefits variously provided by such embodiments include, but are not limited to, an increased effective amount of cache associativity, a reduced observability of cache contention, a decoupling of actual evictions from cache-set contention, and increased side-channel security at longer re-keying intervals. Some embodiments variously provide cache randomization functionality in combination with cache skewing to improve security against contention-based cache attacks (where, for example, use of a victim cache enables a reduction to a rate of key refreshes).

For example, in various embodiments, cache eviction circuitry 126 (for example) variously evicts lines from the cache 152 over time, and puts them into cache 154. In one such embodiment, cache insertion circuitry 124 variously reinserts some or all such evicted lines into the cache 152 at different times. For example, when there is a hit for a line in cache 154, that line is automatically evicted from cache 154 by cache eviction circuitry 126, and reinserted into cache 152 by cache insertion circuitry 124. In one such embodiment, control circuitry 120 maintains two indices idx_{VC,insert} and idx_{VC,reinsert} which identify (respectively) an item that has been most recently inserted into cache 154, and an item that has been most recently reinserted into cache 152. In providing a VC with cache management functionality that automatically reinserts lines from cache 154 to cache 152, some embodiments variously hide contention in cache 152 by decoupling evictions in cache 154 from evictions in cache 152.

Some embodiments variously provide a randomized victim cache (VC) for at least one other corresponding “primary” caches to efficiently mitigate security risks such as contention-based side-channel attacks. In some embodiments, a primary cache is also a randomized cache (RC). In one such embodiment, a given line is evicted from a primary cache, and is put into a corresponding VC—e.g., before a subsequent eviction of said line into memory. The VC may be implemented as a fully associative cache, or as a set-associative cache, that independently uses a secret, randomized mapping. Either the primary cache or the VC implements a randomized replacement policy to add noise to an attacker's cache observations. The proposed solution thus hinders observations of cache contention to reduce the re-keying rates, increase the security margin, and maintain cache performance. In various embodiments, some re-keying is performed to generate one or more new cryptographic keys which are to be used for accessing a victim cache (e.g., in addition to that which is performed to generate new keys for accessing a primary cache).

Some fine-grained contention-based cache attacks exploit contention in cache sets, wherein an attacker typically needs some minimal set of addresses that map to the same cache set as the victim address of interest, a so-called eviction set. Randomization of a primary cache increases the complexity of finding such eviction sets due to the pseudo-random address-to-set mapping. Primary cache randomization on its own is often insufficient for many types of attacks—e.g., wherein regular encryption key updates are further relied upon. However, encryption key updates are often problematic for the performance of cache memory systems.

Some embodiments variously mitigate a long-standing security problem by closing cache-based side and covert channels that have been used in recent speculative execution attacks, to break cryptographic code, and (for example) bypass ASLR. Such embodiments increase the security of products at low performance overheads, and/or lower implementation complexity.

The use of a VC according to some embodiments hinders profiling techniques by breaking a direct observability of cache-set contention. For example, an attacker address X, which conflicts with a victim access C, can be evicted into a VC after a line V is evicted from the VC into memory. The attacker can then observe a miss for the line V, but this line is completely unrelated to the cache-set contention between X and C in the primary cache. As a result, the attacker's attempts using X do not contribute to an eviction set.

It might be possible for an attacker to improve visibility into cache-set contention in a primary cache—e.g., by trying to flush the VC. However, such flushing the VC could be done only indirectly by creating contention in the primary cache—e.g., by causing lines to move to the VC and evict other lines from there. Moreover, such an approach creates noise in the attacker's profiling observations, wherein such noise is proportional to the size of the victim cache. For example, the fraction of lines that is sampled by the attacker that are truly conflicting (and not noise) is

$$∼ \frac{1}{{N}_{vc}} .$$

This extends the attacker's profiling effort proportional to N_{VC}, the number of lines in the VC. In some embodiments, a frequency of encryption key updating can thus by reduced, in proportion to N_{VC}, for improved cache performance without substantially increased security risk.

Some embodiments extend the concept of cache randomization for use in the accessing of a victim cache—e.g., to increase the security against contention-based cache attacks and to reduce the required key refresh rate. In various embodiments, randomization of access to a cache (e.g., access to a victim cache and/or access to a primary cache) is implemented with an encryption or hashing functionality in the memory pipeline. In one such embodiment, a set of keys is generated—e.g., randomly—upon startup, wherein said keys are stored, and (for example) changed at a configurable interval. For example, some embodiments provide cryptographic protection using a QARMA block cipher, a PRINCE block cipher, a SPECK block cipher, or any of various other suitable block ciphers.

In some embodiments, a VC is a set associative (or alternatively, a fully associative) cache that, for example, is looked up in parallel to a looked up of primary cache. The accessing of a set-associative VC is based (for example) on the derivation of a secret set index using cryptography and a secret key. In one embodiment, such derivation is performed using the same cryptographic primitive as is used for accessing the primary cache. For example, some embodiments use the same cryptographic functionality to derive indices for both the primary cache and the VC, but where the caches are accessed using different respective keys. In some embodiments (e.g., wherein the block size of a cryptographic primitive is significantly large), non-overlapping subsets of the output bits from a cryptographic routine are used each to obtain a different respective one of set indices which are each for a different one of the VC or the primary cache.

For example, one illustrative embodiment provides a randomized cache (RC) as a primary cache. Such an RC comprises (for example) N=s·w lines—wherein s is a number of sets, and w is a number of ways—which are organized in 1≤d≤w divisions by grouping together

$$1 \leq \frac{w}{d} \leq w$$

ways in each division. By way of illustration and not limitation, for one such primary cache, N=32, s=8, w=4, and d=2, in an embodiment. The primary cache is skewed by such divisions—e.g., wherein accessing the cache comprises using a different index to select the set in each division. These indices are derived via a cryptographic scheme which based (for example) on a block cipher E or a keyed hash function H within the memory pipeline. Namely, as a given cache line address C is looked up in the primary cache, it is first encrypted (or hashed) using a block cipher E (or hash function H) with d different keys K₀, K₁, . . . , K_{d-1} to obtain d differently encrypted (hashed) addresses C_{enc,0}, C_{enc1}, . . . , C_{enc,d-1}. Slicing out log₂ s bits from these encrypted (hashed) addresses gives d different indices idx₀, idx₁, . . . , idx_{d-1} to select the sets S_{0,idx}_{₁}, . . . , S_{d-1,idx}_{_{d−1}} from the d divisions. On every cache access, these sets are looked up in parallel and if the line cannot be found, one of these sets is randomly chosen for inserting the line. Within this set, any of various suitable replacement algorithm may be used. In some embodiments, the keys K₀, K₁, . . . , K_{d-1} are regularly changed, since (for example) the pseudorandom mapping C→idx₀, idx₁, . . . , idx_{d-1} can be learned over time. Without such re-keying, an attacker could more easily learn the pseudorandom mapping and hence victim secrets, e.g., cryptographic keys, using contention-based cache attacks. Therefore, it is preferable for a re-keying interval to be sufficiently small to make such attacks infeasible.

It is to be noted that the primary cache is not a skewed cache, in some embodiments. Namely, for some embodiments, a primary cache may be realized using d=1 divisions with w ways, in which case the primary cache is a traditional set-associative cache that (for example) uses a randomized set index that is derived by a cryptographic scheme using a block cipher E or a keyed hash function H.

Some embodiments further comprise a victim cache (VC) that, for example, is realized as a fully associative victim cache—with some w_{VC} ways—or as a randomized, set-associative cache with w_{VC} ways and s_{VC} sets, i.e., with N_{VC}=s_{VC}·w_{VC} lines. In one embodiment, such a randomized, set-associative VC uses a cryptographic function based on a block cipher E (hash function H) and a secret key K_{VC} to derive the VC's set index from the cache line address. Lines that are evicted from the primary cache are put into the VC. Lines that hit in the VC can be reinserted into the primary cache but may also stay in the VC without loss of security. To introduce randomness into replacement decisions, either the VC or the primary cache uses a randomized replacement policy. For a good performance-security trade-off, the primary cache in some embodiments uses a well-performing replacement algorithm like (Quad-Age/Octa-Age)-LRU, whereas the victim cache will use random replacement.

Supplementing a primary cache with a VC as described herein increases the primary cache's security margin for contention-based cache side-channel attacks as the VC obfuscates contention in the primary cache and the VC thus allows to extend the primary cache's re-key interval. Moreover, a VC with random replacement helps achieve better performance of the randomized cache architecture through reduced re-keying intervals and (for example) by allowing the secure use of least recently used (LRU) replacement inside the primary cache. Note that primary caches with a VC are not only applicable to actual caches, but also to coherence directories—e.g., including snoop filters—and, for example, to combinations of a cache and a coherence directory.

In an illustrative scenario according to one embodiment, on a memory request to a line C, cache controller circuitry maps the respective address to one or more locations (e.g., sets) in the victim cache—for example, via a cipher E—and further maps the respective address to one or more sets in a primary cache. The cache controller circuitry then looks up the line C in both the primary cache set(s) and the VC location(s). If the line C is found in the primary cache, the line is simply returned. If the line C hits in the VC, the line is returned and (in some embodiments) reinserted into one of the primary cache sets previously determined for line C via the cipher E. Alternatively, the line that was hit in the VC is further maintained in the VC—e.g., without being reinserted into the primary cache. If a reinsertion of C into the primary cache conflicts with another line Y in the primary cache, then (in some embodiments) this other line Y is evicted to memory. In other embodiments, this other line Y is instead evicted from the primary cache to where line C was in the VC, i.e., wherein lines C and Y are swapped. In some embodiments, such swapping of lines C and Y takes place only where they both map to the same set in the VC, which automatically is the case for a fully associative VC. Otherwise, Y must be inserted in the VC set it maps to.

In another scenario, if a request to line C misses in both the primary cache and the VC, the line C is fetched from memory and inserted in one of the sets of the primary cache as determined for line C by the cipher E before. If this insertion conflicts with some line X stored in the primary cache before, the line X is moved from the primary cache to the VC. For a set-associative VC, this first requires deriving the set index of the line X in the set-associative VC via the cipher E. Moving the line X to the VC may cause eviction of another line V from the victim cache to the memory. Note that some embodiments use a scrubber that automatically walks the sets of the VC to randomly evict lines from the VC to the memory to ensure free slots are available whenever a line X is evicted from the primary cache to the VC.

Some embodiments provide address mapping of the primary cache, wherein all lines in the primary cache and a VC are initially invalid, for example. As used herein, the label, S_{i,j} denotes a set j in a division i of a primary cache, wherein Kᵢ and idxᵢ denote, respectively, a key and a set index which correspond to division i. A given cache line address C is mapped to various primary cache entries by an encryption of C with d different keys K₀, K₁, . . . , K_{d-1}, from which log₂ s bits are sliced out to obtain indices idx₀, idx₁, . . . , idx_{d-1}. Said indices are variously used to access d divisions, which results in d cache sets S_{0,idx0}, S_{1,idx1}, . . . , S_{d-1,idx}_{_{d−1}} with

$$\frac{w}{d}$$

entries each.

In some embodiments, a cache line C is mapped to VC entries by encrypting C with the key K_{VC}, log₂ s_{VC} bits of which are sliced out to obtain the index idx_{VC}. In one such embodiment, said index idx_{VC} is used to access the cache set S_{VC,idx}_{_{VC}} in a set-associative VC. In an alternative embodiment, wherein the VC is fully associative, the VC has only one set S_{VC,0} that is directly obtained by selecting idx_{VC}=0 without the need to derive a set index through encryption.

When a given cache line address C is requested, it is mapped to cache sets S_{0,idx}_{₀}, S_{1,idx}_{₁}, . . . , S_{d-1,idx}_{_{d−1}} of the primary cache via any of various suitable primary cache mapping routines, such as one of those described herein. The address C is further and mapped to the VC cache set S_{VC,idx}_{_{Vc}} via any of various suitable victim cache mapping routines, such as one of those described herein. The primary cache cache sets and the VC cache set are then looked up in parallel to find C. If the request hits in set S_{i,idx}_{ᵢ}, the line is directly returned and (in one embodiment) the replacement bits in S_{i,idx}_{ᵢ} are updated. If the request hits in the VC cache set, any of various suitable VC hit operations is performed, as described herein. If the request misses in both the VC and the primary cache, any of various suitable primary cache insert operations is performed, as described herein.

In one example scenario, line C is fetched from memory for insertion into one of multiple sets S_{0,idx}_{₀}, S_{1,idx}_{₁}, . . . , S_{d-1,idxd}_{_{d−1}} in a primary cache. Furthermore, a division \hat{d} ∈ {0, . . . , d−1} of the primary cache is chosen—e.g., randomly—to select one set S_{\hat{d},idx}_{_{\hat{d}}} of the multiple sets. Then a victim line X in the selected S_{\hat{d},idx}_{_{\hat{d}}} is chosen—e.g., according to the set's replacement policy. This victim line X is then replaced by line C, and the replacement bits in s_{\hat{d},idx}_{_{\hat{d}}} are updated. If X was a valid line, it is inserted in the VC—e.g., wherein X is first mapped to a respective VC set S_{VC,idx}_{_{Vc}} through any of various VC mapping operations described herein, and wherein X is subsequently inserted into a free entry in S_{VC,idx}_{_{Vc}}. If there is no free entry available in S_{VC,idx}_{_{Vc}}, a victim line V is selected in S_{VC,idx}_{_{Vc}} according to the VC set's replacement policy for insertion of X— e.g., wherein V is evicted to memory, and X is inserted at the position of V. In one such embodiment, the replacement bits in S_{VC,idx}_{_{Vc}} are updated as needed.

In another example scenario, a cache request hits in the VC, wherein a line V is returned by the hit. In one such embodiment, the line V is reinserted into the primary cache due to the hit—e.g., using any of various primary cache reinsert operations described herein. In another such embodiment, the line V is instead kept in the VC, but the replacement bits for the location (e.g., the set) of line V in the VC are updated as needed.

In another example scenario, wherein a line V in a VC is to be reinserted into a primary cache, a division \hat{d} ∈ {0, . . . , d−1} of the primary cache is selected—e.g., randomly—and the line address V is encrypted with the respective division's key K_{\hat{d}}. From the resulting ciphertext V_{enc,\hat{d}}, log₂ s bits are sliced out to obtain an index idx_{\hat{d}}, which is used to select the cache set S_{\hat{d},idx}_{_{\hat{d}}} in division d. Within set S_{d,idx}_{_{d}}, a victim line Y is selected according to a replacement policy of the cache set. The line V is inserted at the position of Y in the primary cache and the replacement bits in in S_{\hat{d},dx}_{_{\hat{d}}} are updated as needed. If the victim line Y is valid, then—in one embodiment—Y is directly evicted to memory. In another such embodiment, wherein (for example) the VC is fully associative, the valid line Y is put into the entry of V inside the VC, i.e., Y and V are effectively swapped.

In some embodiments, access to a victim cache is randomized by the use of an encryption calculation or a hash calculation to identify (e.g., including calculating an index of) a particular set of a set-associative victim cache, for example. In one such embodiment, an encryption or hash calculation which is performed to identify a given set of the primary cache is different than another encryption or hash calculation which is performed to identify a given set of the victim cache. Such calculations use different respective encryption keys or different respective hash functions, for example.

In one embodiment, a first form in which information is cached to a given entry of the preliminary cache is different than a second form in which that same information is cached, at a different time, to an entry of the victim cache. For example, one (e.g., only one) of the first form or the second form is a plaintext form—for example, wherein the other of the first form or the second form is an encrypted form. In another embodiment, the first form and the second form correspond to different respective encryption types which, for example, are each based on a different respective encryption key, or a different respective cipher. The particular forms of the cached information will determine whether—and if so how—a given line is to be decrypted and/or (re)encrypted if, for example, the line is evicted from the preliminary cache to the victim cache, if the line is reinserted from the victim cache to the preliminary cache

In still another embodiment, a single cipher block is used to generate a single cryptographic primitive, but various (e.g., non-overlapping) bits of the primitive are used to select different respective cache sets including—for example—one or more sets of the primary cache and/or one or more sets of the victim cache. For example, a single cryptographic block cipher generates a 32-bit output, wherein the most significant 16 bits are used to facilitate randomized access of a preliminary cache set, and the least significant 16 bits are used to facilitate randomized access of a victim cache set.

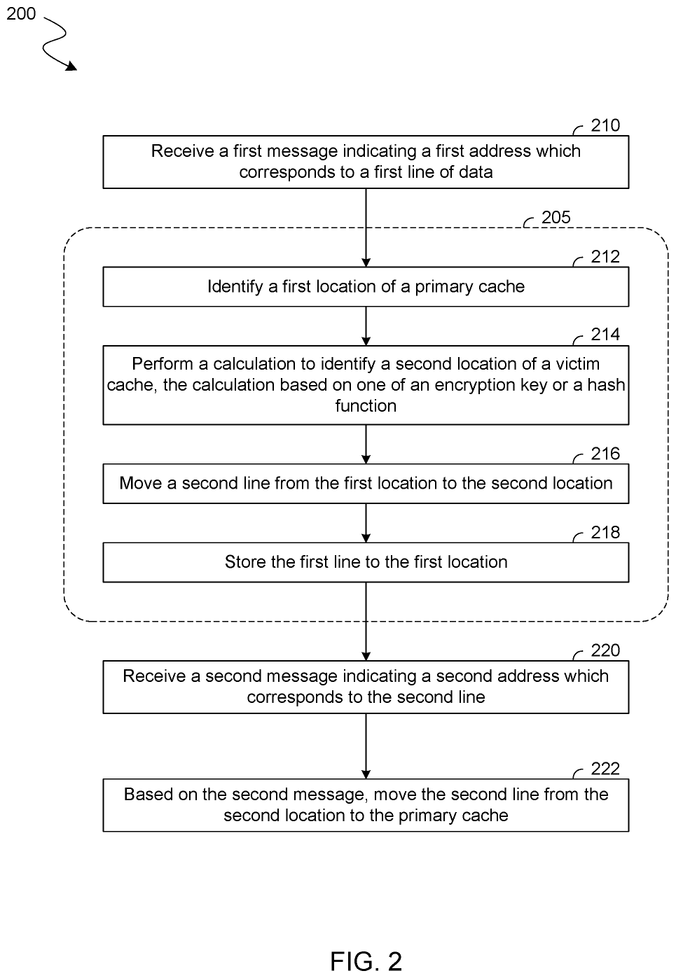

FIG. 2 shows features of a method 200 to operate a cache memory system according to an embodiment. Method 200 illustrates one embodiment wherein a line is evicted from a primary cache (such as a randomized and/or skewed cache) to a randomized victim cache, wherein—in some embodiments—the line is subsequently reinserted from the victim cache to the primary cache in response to a request to access the line. Performance of method 200 is provided with circuitry such as that of processor 100, for example.

As shown in FIG. 2, method 200 comprises (at 210) receiving a first message indicating a first address which corresponds to a first line of data. In one illustrative embodiment, the first message is received by control circuitry 120 based on an execution of software process with execution circuitry 110. The first message is, for example, a request to search a primary cache and a second cache (e.g., in caches 152, 154, respectively) for a first line, where the second cache is to function as a victim cache with respect to the primary cache. Alternatively, the first message is a request to cache the first line (where, for example, the first line has already been retrieved from some memory that is external to processor 100).

Method 200 further comprises operations 205 which are performed based on the first message which is received at 210. In an embodiment, operations 205 comprise (at 212) identifying a first location of a primary cache—e.g., wherein cache look-up circuitry 122 performs operations to identify one or more sets of the primary cache which have been mapped to the indicated first address. For example, cache look-up circuitry 122 performs a look-up, encryption, hash or other operation to identify one of multiple indices which are based on the first address, and which each correspond to a different respective set of the primary cache.

In some embodiments, the primary cache is operated as a random and/or skewed cache. For example, the first location is identified at 212 based on a selected one of first indices which are determined—by cache look-up circuitry 122 (or other suitable cache controller logic)—based on the first address and a first plurality of key values. The first indices—generated using a cipher block or hash function, for example—each correspond to a different respective one of multiple sets of the primary cache (e.g., where the sets are each in a different respective division of the primary cache). At some other time, access to the multiple sets is instead provided with second indices which are determined based on the first address and a second plurality of alternative key values—e.g., wherein control circuitry 120 changes indexing of the primary cache to help protect from side-channel (or other) attacks.

Operations 205 further comprise (at 214) performing a calculation to identify a second location of a victim cache, wherein the calculation is based on one of an encryption key or a hash function. In one example embodiment, determining the second location comprises mapping the first address to a set of the victim cache—e.g., wherein the mapping comprises calculating an index for the set based on the first address and the one of the encryption key or the hash function. In one such embodiment, an address C is mapped to a particular set of a victim cache by encrypting C with a key K_{VC}, slicing out log₂(s_{VC}) bits to obtain an index idx_{VC}, and using this index to access a set S_{VC,idxVC} of the set-associative victim cache.

Operations 205 further comprise (at 216) moving a second line from the first location to the second location of the victim cache. For example, moving the second line to the second location at 216 is based on cache insertion circuitry 124 (or other suitable cache controller logic) detecting a valid state of the second line. In some embodiments, operations 205 further comprise evicting a third line from the second location to a memory (e.g., an external memory which is coupled to processor 100) before moving the second line from the first location to the second location. In one such embodiment, evicting the third line is based on cache insertion circuitry 124 (or other suitable cache controller logic) detecting a valid state of the third line. Operations 205 further comprise (at 218) storing the first line to the first location, which (for example) is available after the moving at 216.

Although some embodiments are not limited in this regard, method 200 additionally or alternatively comprises operations to reinsert a line from the victim cache to the primary cache. For example, in one such embodiment, method 200 further comprises (at 220) receiving a second message indicating a second address which corresponds to the second line. The second message (e.g., received by control circuitry 120) is, for example, a request to search for the second line in the primary cache and the second cache. Based on the second message received at 220, method 200 (at 222) moves the second line from the second location to the primary cache.

In one such embodiment, moving the second line at 222 comprises swapping the second line and a third line between the primary cache and the second cache—e.g., based on the detecting of a valid state of the third line. In an alternative scenario (e.g., wherein the third line is invalid), the moving at 222 simply writes over the third line. In some embodiments, the moving at 222 comprises identifying the second location in the victim cache—e.g., by performing operations, such as those referred to above, to calculate or otherwise identify the corresponding index idx_{VC} based on an encryption key or a hash function.

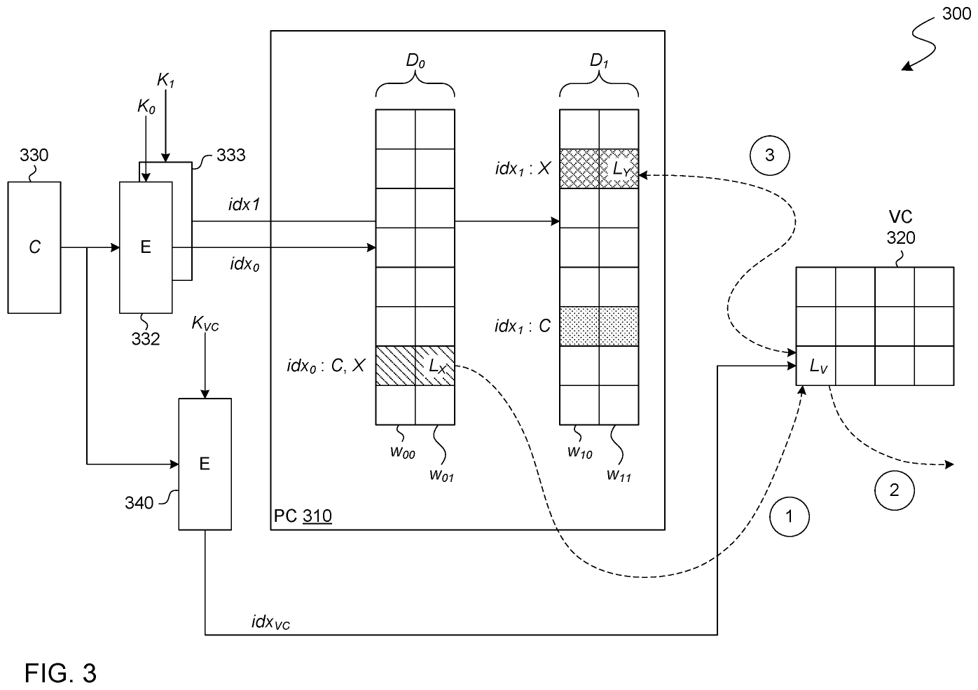

FIG. 3 shows operations performed by a system 300 to manage memory caches according to an embodiment. In various embodiments, system 300 includes features of processor 100—e.g., wherein functionality such as that of system 300 is provided according to method 200.

As shown in FIG. 3, system 300 comprises a primary cache (PC) 310 and a victim cache VC 320 which, for example, correspond functionally to caches 152, 154 (respectively). In the illustrated embodiment, PC 310 comprises N=(s·w) lines (where the number of sets s is equal to 8, the number of ways w is equal to 4, and the number of lines N is equal to 32), which are divided into d=2 divisions. Furthermore, VC 320 comprises s_{VC} sets and w_{VC} ways (e.g., where svc is equal to three, and w_{VC} is equal to 4). The respective numbers of sets and/or numbers of ways in PC 310 and VC 320 are merely illustrative, and are not limiting on other embodiments.

In an example scenario according to one embodiment, system 300 receives or otherwise communicates a request 330 which provides an address C to indicate, at least in part, that a line L_{C} corresponding to the address C is to be cached, read, evicted, or otherwise accessed. For example, request 330 is communicated by execution circuitry 110 to control circuitry 120 to determine whether either of caches 152, 154 stores some cached version of line L_{C}.

In one such embodiment, the address C is mapped (e.g., by circuit blocks 332, 333 provided, for example, with cache look-up circuitry 122) to multiple sets of PC 310, where each such set at a different respective division of PC 310. Such mapping is based, for example, on a cipher E (or alternatively, based on a hash function H) and a set of keys including, for example, the illustrative keys K₀, K₁ shown. Furthermore, the address C is also mapped (e.g., by a circuit block 340 provided, for example, with cache look-up circuitry 122) to a set of VC 320. Such mapping is based, for example, on a cipher E (or alternatively, based on a hash function H) and another key including, such as the illustrative key K_{VC} shown. For example, circuit blocks 332, 333 generate respective indices idx₀, idx₁ to variously access sets which are each in a different respective one of divisions D₀, D₁—e.g., wherein circuit block 340 generates another index idx_{vc} to access a set in VC 320. In one such embodiment, indices idx₀, idx₁, idx_{vc} are variously generated each based on the same cipher E (or the same hash function, for example).

Based on a request for the line L_{C}, a look up operation is performed to see if a mapped set in VC 320, or any of the mapped sets in PC 310, includes the line L_{C}. Where the line L_{C} is found in PC 310, said line L_{C} is simply returned in a response to the request. However, where the line L_{C} is found in VC 320, said line L_{C}—in addition to being returned in response to the request—is also evicted from VC 320 and reinserted into PC 310 (e.g., at one of those sets of PC 310 which are mapped to the address C).

In an embodiment, if reinsertion of line L_{C} from VC 320 to PC 310 conflicts with some other line which is currently in PC 310, then that other line is swapped with the line L_{C}—e.g., wherein the line L_{C} is inserted into the location where PC 310 stored the other line, and where that other line is evicted to the location where VC 320 stored the line L_{C}.

If the request for the line L_{C} misses—that is, where neither of PC 310 or VC 320 currently has line L_{C}—then the line L_{C} is fetched from an external memory (not shown) and, for example is inserted into one of the sets of PC 310—e.g., as determined based on the address C and a cipher E (or a hash function H, for example). If an insertion of the line L_{C} conflicts with some second line L_{X} which is currently stored in PC 310, then that second line L_{X} is evicted from PC 310 to VC 320. In some cases, such eviction of the line L_{X} from PC 310 to VC 320 results in eviction of some third line L_{V} from VC 320 to memory. In some embodiments, reinsertion of a given line from a victim cache to a primary cache comprises the cache management circuitry trying to reinsert the line into a different cache way (and, for example, a different division) other than the one from which the line was originally evicted.

In various embodiments, use of VC 320 (and randomized access thereto) with PC 310 hinders some side-channel attacks by breaking the direct observability of cache-set contention. In an illustrative scenario according to one embodiment, an attacker uses a line L_{X} which corresponds to an attacker address X that conflicts with an address C of a line L_{C}. Servicing of a request for line L_{C} results in the line L_{X} being evicted from PC 310 into VC 320, which in turn results in an eviction of another line L_{V} from VC 320 into memory (as indicated by the line transfer operations labeled “1” and “2” in FIG. 3). Such eviction of line L_{V} to memory would contribute to a cache miss by some later request for line L_{V}—e.g., where a malicious agent is probing for such misses as part of a side-channel attack. However, this miss would not be detected as being related to the cache-set contention between lines L_{X}, L_{C} in PC 310, where (for example) the attacker line L_{X} is subsequently reinserted into PC 310.

For example, in a first example situation, a later request for line L_{X} would result in line L_{X} being reinserted from VC 320 back into the same division where it was originally stored in PC 310. This would result in the line L_{C} (corresponding to address C) being selected for eviction to VC 320, i.e., wherein line L_{X} and the line L_{C} are swapped. As a result, line Lx and the line L_{C} are stored in PC 310 and VC 320 (respectively), making the previous contention in PC 310 invisible.

In a second example situation, the line Lx is instead reinserted from VC 320 into a division of PC 310 other than the one from which it was previously evicted. As a result, the line L_{C} is not selected for eviction from PC 310—e.g., where (for example) some other line L_{Y}, previously stored in PC 310, is instead swapped with the line L_{X} (as indicated by the line swap operation labeled “3” in FIG. 3). If line L_{Y} is invalid, the previous contention in PC 310 becomes invisible. If line L_{Y} is valid, a malicious agent could conceivably be able to observe a miss on line L_{Y} if (for example) it manages to flush VC 320.

Evictions observed by a malicious agent thus appear to be unrelated to the victim address C, or to have an only indirect relationship to the victim address. An indirectly contending address Y might arise in the following situation: line L_{Y} evicts line L_{X}, and then line L_{X} evicts line L_{C}. Hence, line L_{X} contends with both line L_{Y} and line L_{C}, depending on the division. Indirectly contending addresses like Y remain sufficiently hard to exploit in practice for multiple reasons. For example, malicious agents cannot distinguish whether they sampled such indirectly contending address, or an unrelated one. This aspect effectively increases the number of addresses required to identify an eviction set.

Furthermore, malicious agents typically do not know what the address X is, because it cannot be observed. However, an indirectly contending address Y is only valuable to a malicious agent if they know address X and insert line Lx before beforehand—i.e., line L_{X} is a required proxy for line L_{Y} to evict line L_{C}. Other addresses are unlikely to contribute this this kind of multi-collision—i.e., it is unlikely for many addresses X′ to contend with both address C and address Y in different divisions. In general, there is roughly a probability of w²s⁻² (e.g., 1 in 4096 addresses for a cache with 1024 sets and 16 ways) that some address would have this property. There is a special case where lines L_{X}, L_{Y} collide with line L_{C} in the same division (which can occur, for example, where d<w). In one such situation, line L_{Y} could directly evict line L_{C} from PC 310, but where VC 320 triggers automatic reinsertion of line L_{C} (effectively preventing eviction).

Further still, even if malicious agents know address X, they have low probability of evicting the victim line L_{C} from PC 310. For example, line L_{C} and line L_{X} must both have been placed in the correct cache ways beforehand, line L_{Y} must be inserted so as to evict line L_{X}, and line L_{X} must be reinserted so as to evict line L_{C} to VC 320. In general, such a sequence for line placements has a probability of roughly w⁻⁴. This significantly increases the number of addresses needed in the eviction set to obtain a good eviction probability.

Further still, the malicious agent would typically need to flush VC 320 with lines for random addresses once line L_{C} was evicted from PC 310 into VC 320. This process requires additional contention in PC 310 and adds “noise” to the probing process of a side-channel attack.

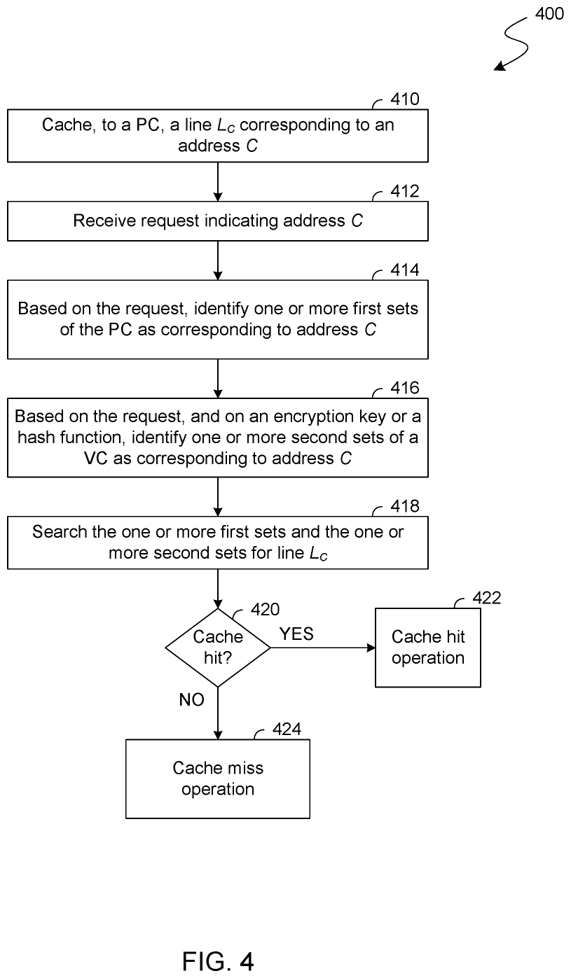

FIG. 4 shows features of a method 400 to move lines of data between different memory caches according to an embodiment. In some embodiments, performance of method 400 is provided with circuitry such as that of processor 100 or system 300—e.g., wherein method 400 includes or is otherwise based on method 200.

As shown in FIG. 4, method 400 comprises (at 410) caching a line L_{C} to a set of a primary cache (PC), wherein the line L_{C} corresponds to an address C which has been mapped to that set. In an illustrative scenario according to one embodiment, an initialization of a data and/or instruction cache system (such as a cache subsystem of processor 100, or system 300) comprises invalidating all lines in a primary cache and all lines in a victim cache (VC). Furthermore, indices idx_{VC,insert} and idx_{VC,reinsert} for the VC are initialized (e.g., to 0) and, for example, are configured to wrap around if they exceed some maximum value, such as (w_{VC}−1). Subsequently the address C, corresponding to line L_{C}, is mapped to entries of the primary cache.

By way of illustration and not limitation, encrypted address values are determined each based on the address C and a different respective one of d keys K₀, K₁, . . . , K_{d-1} (where a given encryption key Kᵢ corresponds to a particular division i of the primary cache). Indices idx₀, idx₁, . . . , idx_{d-1} are then obtained—e.g., each by identifying a respective slice of log₂ s_{pc} bits from a corresponding one of the encrypted address values (where a given set index idxᵢ corresponds to a particular division i of the primary cache). Said indices are available to be used each to access a respective one of the d divisions—e.g., to access any of d cache sets S_{0,idx0}, S_{1,idx1}, . . . , S_{d-1,idxd-1} (where, for a given set S_{i,j}, index i indicates a particular division, and index j indicates a particular set of that division i). In some embodiments, the d cache sets S_{0,idx0}, S_{1,idx1}, . . . , S_{d-1,idxd-1} comprise w/d entries each, for example.

Method 400 further comprises (at 412) receiving a request—such as the request 330 communicated with system 300—which indicates the address C, and (at 414) identifying, based on the request which is received at 412, one or more first sets of the primary cache which have been mapped to the address C. For example, at some point after the mapping of primary cache sets, a request to access the line L_{C} provides the corresponding address C, which is used by control circuitry 120 (or other suitable cache control logic) to determine the corresponding mapped one or more sets—e.g., sets S_{0,idx0}, S_{1,idx1}, . . . , S_{d-1,idxd-1}—of the primary cache.

Based on the request received at 412—and further based on an encryption key or a hash function—method 400 (at 416) identifies one or more second sets of a VC as corresponding to the address C. By way of illustration and not limitation, an encrypted address value is determined based on both the address C and another key K_{vc}. In some embodiments, an index id_{vc} is thus obtained—e.g., each by identifying a slice of some log₂ s_{vc} bits from the encrypted address value. Said index is available to be used to access a corresponding set S_{VC,idxVC} of the (set-associative, for example) victim cache.

Method 400 further comprises (at 418) searching the one or more first sets which were identified at 414—as well as the one or more second sets which were identified at 416—for the line L_{C} (where said searching is based on the request received at 412). For example, look-ups of the mapped sets of the PC and VC are then performed (in parallel, for example) to search for the line L_{C}. In some embodiments, if the request hits in some mapped set of the primary cache, then the line L_{C} is returned in a response to the access request, and—in some embodiments—replacement bits in the set S_{i,idxi} are updated. If the request hits in the VC, then a VC hit operation is performed (as described herein). If the request misses in both the VC and the PC, a primary cache insert operation is performed (as described herein).

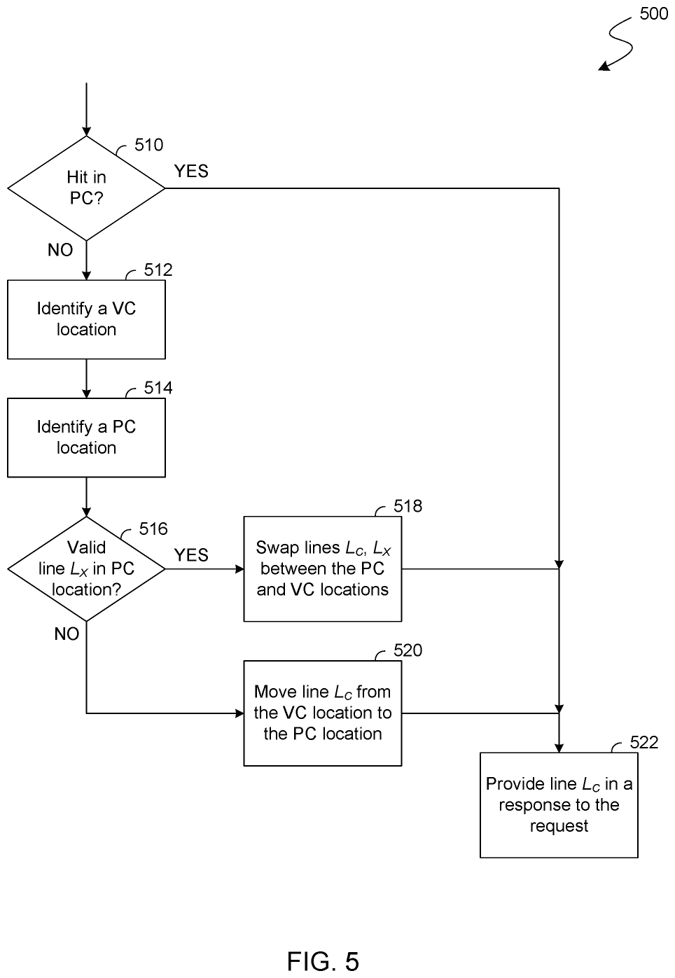

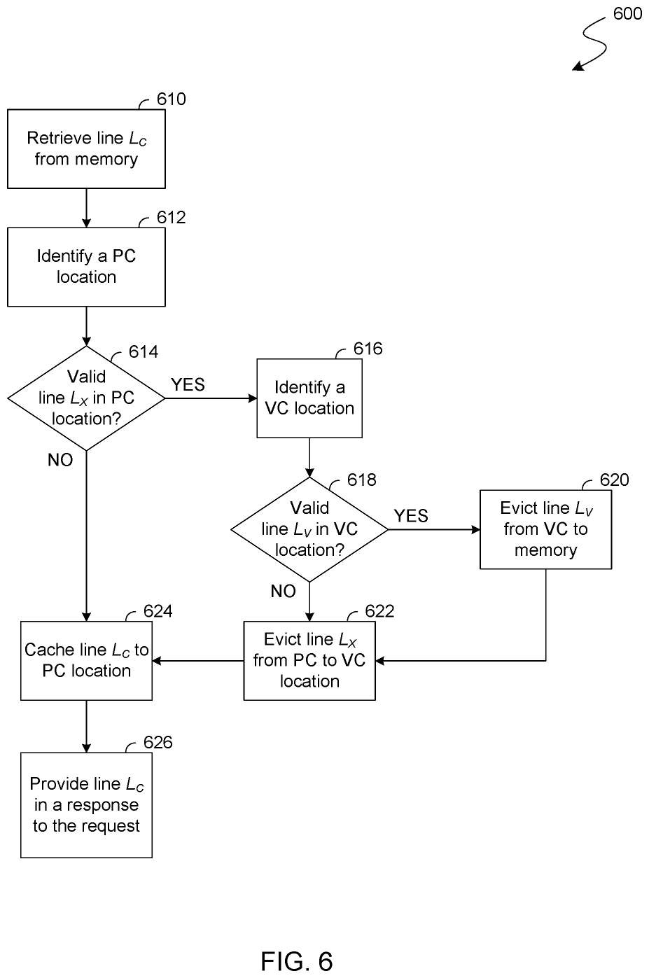

For example, method 400 determines (at 420) whether or not the searching at 418 has resulted in a cache hit—i.e., wherein the line L_{C} has been found in either of the primary cache or the victim cache. Where a cache hit is detected at 420, method 400 (at 422) performs operations to access one or more lines of the primary cache or the victim cache based on the cache hit. In various embodiments, the cache hit operations at 422 include moving one line between respective sets of the primary cache and the victim cache. In one such embodiment, the cache hit operations at 422 further comprise moving a line between an external memory and one of the primary cache or the victim cache. In various embodiments, cache hit operation 422 includes some or all of the method 500 shown in FIG. 5.

Where it is instead determined at 420 that no such cache hit is indicated, method 400 (at 424) performs operations to cache a line from an external memory to the primary cache based on the detected cache miss. In various embodiments, the cache miss operations at 424 include moving another line between respective sets of the primary cache and the victim cache. In one such embodiment, the cache miss operations at 424 further comprise moving a line between an external memory and one of the primary cache or the victim cache. In various embodiments, cache miss operation 424 includes some or all of the method 600 shown in FIG. 6.

In various embodiments, a victim cache hit operation—in response to a data request hitting a line which is stored in a victim cache—comprises control circuitry 120 (or other suitable cache control logic) returning the line in a response to the request, and also reinserting that line into a primary cache using a primary cache reinsert routine. By way of illustration and not limitation, reinsertion of a line from the victim cache into the primary cache is automatically triggered if, for example, the index idx_{VC,reinsert} is less than the index idx_{VC,insert}. Subsequently, the index idx_{VC,reinsert} is incremented or otherwise updated. In one such embodiment, reinsertion of the requested line from the victim cache into the primary cache, includes randomly selecting or otherwise identifying a division d \hat{ }∈ {0, . . . , d−1}, where a line address C corresponding to the requested line is encrypted with the respective division's key K_{d}. From a resulting ciphertext C_{enc,d\hat{ }}, log₂ s_{pc} bits are sliced out to obtain index idx_{d\hat{ }}, which is used to select the cache set S_{d\hat{ },idxd\hat{ }} in division d\hat{ }. Within S_{d\hat{ },idxd\hat{ }}, a victim line L_{X} is selected—e.g., according to a replacement policy for the cache set. The requested line in the victim cache and line L_{X} in the primary cache are then swapped (e.g., if line L_{X} is valid) and the replacement bits in S_{d\hat{ }, idxd\hat{ }}are updated. Afterwards, the requested line, and the line L_{X} will be in the primary cache and the victim cache, respectively.

For example, FIG. 5 shows features of a method 500 to operate a cache based on a cache hit according to an embodiment. Performance of method 500 is provided with circuitry such as that of processor 100 or system 300—e.g., wherein method 500 includes, or is performed in combination with, one or more operations of method 400. For example, the cache hit operation 422 of method 400 includes some or all of method 500, in some embodiments.

As shown in FIG. 5, method 500 comprises determining (at 510) whether or not a cache hit—such as one detected at 420—was at a primary cache. Where it is determined at 510 that the detected cache hit was at the primary cache (e.g., rather than at a corresponding victim cache), method 500 (at 522) provides the line L_{C} in a response to a previously-detected request—such as the one received at 412—which indicates an address C corresponding to the line L_{C}.

By contrast, where it is instead determined at 510 that the detected cache hit was not at the primary cache, but rather at a victim cache which corresponds to the primary cache, method 500 performs a victim cache hit process which includes (at 512) identifying the location in the victim cache from which the line L_{C} is to be evicted. Furthermore, method 500 (at 514) identifies a location in the primary cache which is to receive the line L_{C} from the victim cache. In one example embodiment, determining a particular location where the victim cache (or for example, where a primary cache) is to receive a given line C comprises mapping the line C in question to an entry of the victim (or primary) cache. For example, a cache line C is mapped to a particular victim cache entry by encrypting C with the key K_{VC}, slicing out log₂(s_{VC}) bits to obtain an index idx_{VC}, and using this index to access a cache set S_{VC,idxVC} in the set-associative victim cache. In various embodiments, wherein a victim cache is fully associative, the victim cache has only one set, S_{VC,0}, which can be directly obtained by selecting idx_{VC}=0—i.e., without a need to derive a set index through encryption.

In one such embodiment, the victim cache hit process of method 500 further determines (at 516) whether or not the location which is identified at 514 currently stores any line L_{X} which is classified as being valid. Where it is determined at 516 that the primary cache location does currently store some valid line L_{X}, method 500 (at 518) swaps the lines L_{C}, L_{X} between the two cache locations which are variously identified at 512 and at 514. Where it is instead determined at 516 that the primary cache location does not currently store any valid line L_{X}, method 500 (at 520) simply moves the line L_{C} from the location identified at 512 to the location identified at 514—e.g., wherein such moving simply writes over data stored in the location identified at 514.

In either case, the victim cache hit process includes, or is performed in conjunction with, the providing of the line L_{C} (at 522) in the response to previously-detected request which indicates the address C. However, some embodiments omit (or provide support for selectively disabling) functionality to reinsert a given line from a victim cache to a primary cache. In one such embodiment, such a line remains in the victim cache until (for example) it is evicted to memory to make room for another line being evicted from the primary cache to the victim cache.

In some embodiments, a primary cache insert process comprises fetching a line L_{C} from a data storage device, and storing the line L_{C} to one of the d sets S_{0,idx0}, S_{1,idx1}, . . . , S_{d-1,idxd-1} of the primary cache which have been mapped to the corresponding address C. For example, one division d\hat{ }− {0, . . . , d−1} is chosen (e.g., randomly) from among the d divisions of the primary cache, wherein a set S_{d\hat{ },idxd\hat{ }}, of the division d\hat{ } is selected, and a victim line L_{X} in the set S_{d\hat{ },idxd\hat{ }}is designated for eviction—e.g., according to a policy which (for example) is adapted from any of various conventional cache replacement techniques. The designated line L_{X} is then replaced by the line L_{C} —e.g., wherein replacement bits in S_{d\hat{ },idxd\hat{ }}are updated accordingly. If the evicted line L_{X} is a valid one at the time of eviction, idx_{VC,insert} is incremented (or otherwise updated) and line L_{X} is inserted into the VC at position idx_{VC,insert}. If some valid line L_{V} is currently at the position idx_{VC,insert} where line L_{X} is to be inserted, then that line L_{V} is evicted from the VC, and written to a higher level cache, to a data storage device (e.g., disk storage), or the like.

For example, FIG. 6 shows features of a method 600 to operate a cache based on a cache miss according to an embodiment. In some embodiments, performance of method 600 is provided with functionality such as that of processor 100—e.g., wherein method 600 includes, or is performed in combination with, one or more operations of method 400. For example, the cache miss operation 424 of method 400 includes some or all of method 600, in some embodiments.

As shown in FIG. 6, method 600 comprises (at 610) retrieving a line L_{C} from a data storage device (e.g., disk storage) which is external to the cache system (and for example, external to processor 100 or other such processing resources). In an embodiment, line L_{C} is retrieved in response to a cache miss which results from a look up of both sets of a primary cache, and of a victim cache which corresponds to that primary cache.

A primary cache insert process of method 600 comprises (at 612) identifying a location in the primary cache which is to receive the line L_{C} that is retrieved at 610. Furthermore, method 600 determines (at 614) whether or not the location which is identified at 612 currently stores any line L_{X} which is classified as being valid. Where it is determined at 614 that the primary cache location does currently store some valid line L_{X}, method 600 (at 616) identifies a location in the victim cache which is to receive the line L_{X} from the primary cache. In various embodiments, identifying the location at 616 is based on an address C which corresponds to the line L_{c}, and is further based on an encryption key or hash function. For example, an encryption calculation is performed based on the address C, and an encryption key K_{VC} as part of operations to determine an index value for a cache set S_{VC,idxVC} in the set-associative victim cache. Subsequently, the primary cache insert process determines (at 618) whether or not the location which is identified at 616 currently stores any other line L_{V} which is classified as being valid.

Where it is determined at 618 that the victim cache location does currently store some valid line L_{V}, method 600 (at 620) evicts the line L_{V} from the victim cache for writing to a higher level cache, to a data storage device (e.g., disk storage), or the like. Subsequently (at 622), the line L_{X} is evicted from the location in the primary cache which is identified at 612, and stored at the location in the victim cache which is identified at 616. By contrast, where it is instead determined at 618 that the victim cache location does not currently store any valid line L_{V}, method 600 performs the evicting at 622, but foregoes the evicting at 620. In either case, method 600 (at 624) caches the line L_{C} to the location which is identified at 612.

In some embodiments, where it is instead determined at 614 that the primary cache location—which was identified at 612—does not currently store any valid line L_{X}, method 600 simply performs a caching of the line to that primary cache location (at 624). Regardless, in some embodiments, a cache miss process includes (or is performed in conjunction with) the providing of the line L_{C} (at 626) in a response to a previously-detected request for line L_{C}.

### Exemplary Computer Architectures.

Detailed below are describes of exemplary computer architectures. Other system designs and configurations known in the arts for laptop, desktop, and handheld personal computers (PC)s, personal digital assistants, engineering workstations, servers, disaggregated servers, network devices, network hubs, switches, routers, embedded processors, digital signal processors (DSPs), graphics devices, video game devices, set-top boxes, micro controllers, cell phones, portable media players, hand-held devices, and various other electronic devices, are also suitable. In general, a variety of systems or electronic devices capable of incorporating a processor and/or other execution logic as disclosed herein are generally suitable.

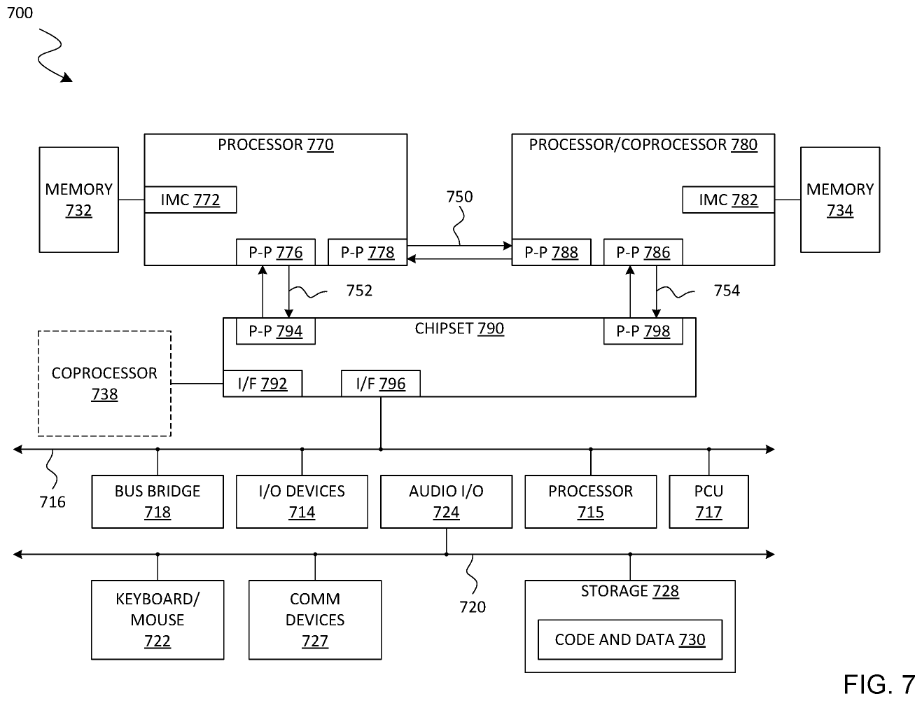

FIG. 7 illustrates an exemplary system. Multiprocessor system 700 is a point-to-point interconnect system and includes a plurality of processors including a first processor 770 and a second processor 780 coupled via a point-to-point interconnect 750. In some examples, the first processor 770 and the second processor 780 are homogeneous. In some examples, first processor 770 and the second processor 780 are heterogenous. Though the exemplary system 700 is shown to have two processors, the system may have three or more processors, or may be a single processor system.

Processors 770 and 780 are shown including integrated memory controller (IMC) circuitry 772 and 782, respectively. Processor 770 also includes as part of its interconnect controller point-to-point (P-P) interfaces 776 and 778; similarly, second processor 780 includes P-P interfaces 786 and 788. Processors 770, 780 may exchange information via the point-to-point (P-P) interconnect 750 using P-P interface circuits 778, 788. IMCs 772 and 782 couple the processors 770, 780 to respective memories, namely a memory 732 and a memory 734, which may be portions of main memory locally attached to the respective processors.

Processors 770, 780 may each exchange information with a chipset 790 via individual P-P interconnects 752, 754 using point to point interface circuits 776, 794, 786, 798. Chipset 790 may optionally exchange information with a coprocessor 738 via an interface 792. In some examples, the coprocessor 738 is a special-purpose processor, such as, for example, a high-throughput processor, a network or communication processor, compression engine, graphics processor, general purpose graphics processing unit (GPGPU), neural-network processing unit (NPU), embedded processor, or the like.

A shared cache (not shown) may be included in either processor 770, 780 or outside of both processors, yet connected with the processors via P-P interconnect, such that either or both processors' local cache information may be stored in the shared cache if a processor is placed into a low power mode.

Chipset 790 may be coupled to a first interconnect 716 via an interface 796. In some examples, first interconnect 716 may be a Peripheral Component Interconnect (PCI) interconnect, or an interconnect such as a PCI Express interconnect or another 110 interconnect. In some examples, one of the interconnects couples to a power control unit (PCU) 717, which may include circuitry, software, and/or firmware to perform power management operations with regard to the processors 770, 780 and/or co-processor 738. PCU 717 provides control information to a voltage regulator (not shown) to cause the voltage regulator to generate the appropriate regulated voltage. PCU 717 also provides control information to control the operating voltage generated. In various examples, PCU 717 may include a variety of power management logic units (circuitry) to perform hardware-based power management. Such power management may be wholly processor controlled (e.g., by various processor hardware, and which may be triggered by workload and/or power, thermal or other processor constraints) and/or the power management may be performed responsive to external sources (such as a platform or power management source or system software).

PCU 717 is illustrated as being present as logic separate from the processor 770 and/or processor 780. In other cases, PCU 717 may execute on a given one or more of cores (not shown) of processor 770 or 780. In some cases, PCU 717 may be implemented as a microcontroller (dedicated or general-purpose) or other control logic configured to execute its own dedicated power management code, sometimes referred to as P-code. In yet other examples, power management operations to be performed by PCU 717 may be implemented externally to a processor, such as by way of a separate power management integrated circuit (PMIC) or another component external to the processor. In yet other examples, power management operations to be performed by PCU 717 may be implemented within BIOS or other system software.

Various I/O devices 714 may be coupled to first interconnect 716, along with a bus bridge 718 which couples first interconnect 716 to a second interconnect 720. In some examples, one or more additional processor(s) 715, such as coprocessors, high-throughput many integrated core (MIC) processors, GPGPUs, accelerators (such as graphics accelerators or digital signal processing (DSP) units), field programmable gate arrays (FPGAs), or any other processor, are coupled to first interconnect 716. In some examples, second interconnect 720 may be a low pin count (LPC) interconnect. Various devices may be coupled to second interconnect 720 including, for example, a keyboard and/or mouse 722, communication devices 727 and a storage circuitry 728. Storage circuitry 728 may be one or more non-transitory machine-readable storage media as described below, such as a disk drive or other mass storage device which may include instructions/code and data 730 in some examples. Further, an audio I/O 724 may be coupled to second interconnect 720. Note that other architectures than the point-to-point architecture described above are possible. For example, instead of the point-to-point architecture, a system such as multiprocessor system 700 may implement a multi-drop interconnect or other such architecture.

### Exemplary Core Architectures, Processors, and Computer Architectures.

Processor cores may be implemented in different ways, for different purposes, and in different processors. For instance, implementations of such cores may include: 1) a general purpose in-order core intended for general-purpose computing; 2) a high-performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput) computing. Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip (SoC) that may include on the same die as the described CPU (sometimes referred to as the application core(s) or application processor(s)), the above described coprocessor, and additional functionality. Exemplary core architectures are described next, followed by descriptions of exemplary processors and computer architectures.

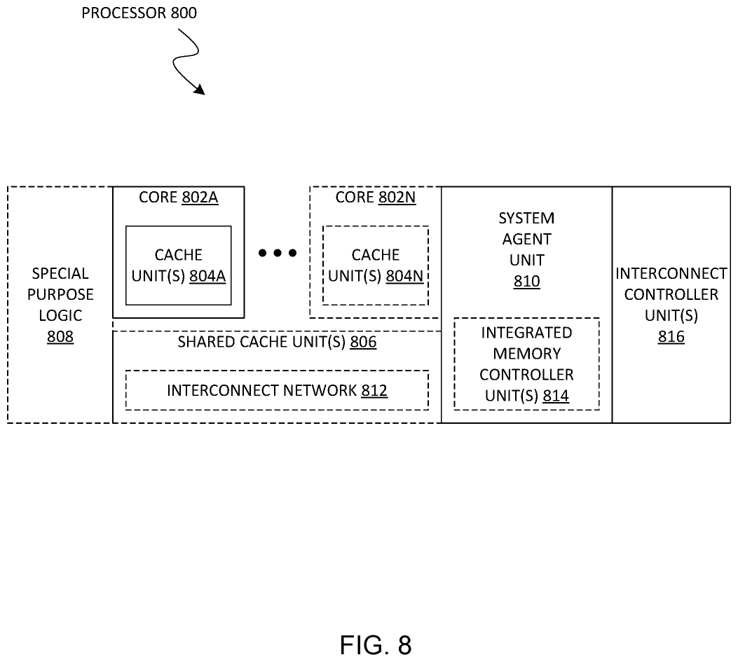

FIG. 8 illustrates a block diagram of an example processor 800 that may have more than one core and an integrated memory controller. The solid lined boxes illustrate a processor 800 with a single core 802A, a system agent unit circuitry 810, a set of one or more interconnect controller unit(s) circuitry 816, while the optional addition of the dashed lined boxes illustrates an alternative processor 800 with multiple cores 802A-N, a set of one or more integrated memory controller unit(s) circuitry 814 in the system agent unit circuitry 810, and special purpose logic 808, as well as a set of one or more interconnect controller units circuitry 816. Note that the processor 800 may be one of the processors 770 or 780, or co-processor 738 or 715 of FIG. 7.

Thus, different implementations of the processor 800 may include: 1) a CPU with the special purpose logic 808 being integrated graphics and/or scientific (throughput) logic (which may include one or more cores, not shown), and the cores 802A-N being one or more general purpose cores (e.g., general purpose in-order cores, general purpose out-of-order cores, or a combination of the two); 2) a coprocessor with the cores 802A-N being a large number of special purpose cores intended primarily for graphics and/or scientific (throughput); and 3) a coprocessor with the cores 802A-N being a large number of general purpose in-order cores. Thus, the processor 800 may be a general-purpose processor, coprocessor or special-purpose processor, such as, for example, a network or communication processor, compression engine, graphics processor, GPGPU (general purpose graphics processing unit circuitry), a high-throughput many integrated core (MIC) coprocessor (including 30 or more cores), embedded processor, or the like. The processor may be implemented on one or more chips. The processor 800 may be a part of and/or may be implemented on one or more substrates using any of a number of process technologies, such as, for example, complementary metal oxide semiconductor (CMOS), bipolar CMOS (BiCMOS), P-type metal oxide semiconductor (PMOS), or N-type metal oxide semiconductor (NMOS).

A memory hierarchy includes one or more levels of cache unit(s) circuitry 804A-N within the cores 802A-N, a set of one or more shared cache unit(s) circuitry 806, and external memory (not shown) coupled to the set of integrated memory controller unit(s) circuitry 814. The set of one or more shared cache unit(s) circuitry 806 may include one or more mid-level caches, such as level 2 (L2), level 3 (L3), level 4 (L4), or other levels of cache, such as a last level cache (LLC), and/or combinations thereof. While in some examples ring-based interconnect network circuitry 812 interconnects the special purpose logic 808 (e.g., integrated graphics logic), the set of shared cache unit(s) circuitry 806, and the system agent unit circuitry 810, alternative examples use any number of well-known techniques for interconnecting such units. In some examples, coherency is maintained between one or more of the shared cache unit(s) circuitry 806 and cores 802A-N.

In some examples, one or more of the cores 802A-N are capable of multi-threading. The system agent unit circuitry 810 includes those components coordinating and operating cores 802A-N. The system agent unit circuitry 810 may include, for example, power control unit (PCU) circuitry and/or display unit circuitry (not shown). The PCU may be or may include logic and components needed for regulating the power state of the cores 802A-N and/or the special purpose logic 808 (e.g., integrated graphics logic). The display unit circuitry is for driving one or more externally connected displays.

The cores 802A-N may be homogenous in terms of instruction set architecture (ISA). Alternatively, the cores 802A-N may be heterogeneous in terms of ISA; that is, a subset of the cores 802A-N may be capable of executing an ISA, while other cores may be capable of executing only a subset of that ISA or another ISA.

### Exemplary Core Architectures-In-Order and Out-Of-Order Core Block Diagram.

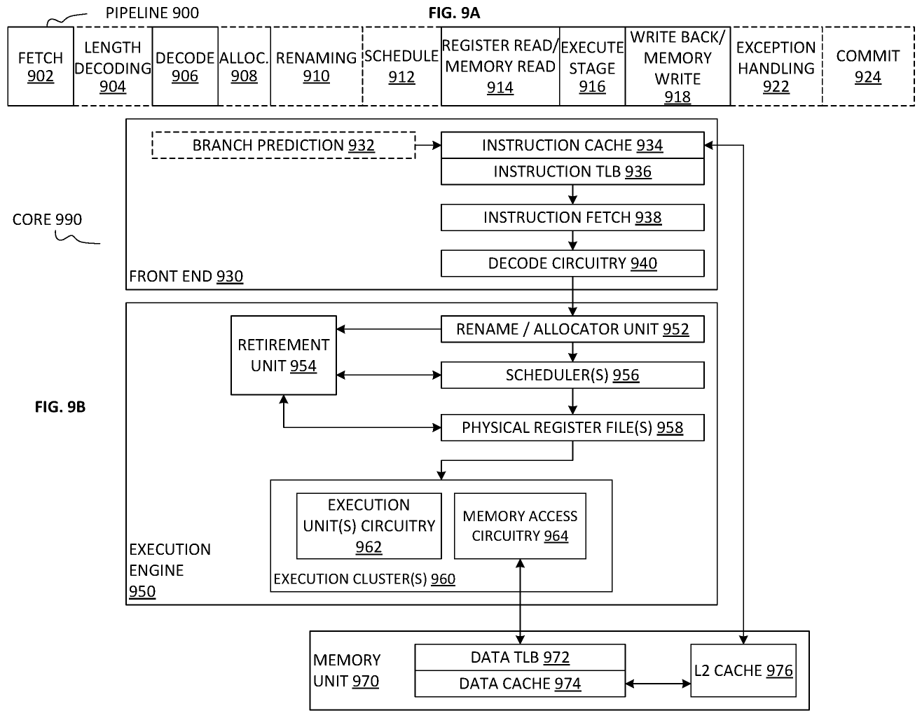

FIG. 9A is a block diagram illustrating both an exemplary in-order pipeline and an exemplary register renaming, out-of-order issue/execution pipeline according to examples. FIG. 9B is a block diagram illustrating both an exemplary example of an in-order architecture core and an exemplary register renaming, out-of-order issue/execution architecture core to be included in a processor according to examples. The solid lined boxes in FIGS. 9A-B illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 9A, a processor pipeline 900 includes a fetch stage 902, an optional length decoding stage 904, a decode stage 906, an optional allocation (Alloc) stage 908, an optional renaming stage 910, a schedule (also known as a dispatch or issue) stage 912, an optional register read/memory read stage 914, an execute stage 916, a write back/memory write stage 918, an optional exception handling stage 922, and an optional commit stage 924. One or more operations can be performed in each of these processor pipeline stages. For example, during the fetch stage 902, one or more instructions are fetched from instruction memory, and during the decode stage 906, the one or more fetched instructions may be decoded, addresses (e.g., load store unit (LSU) addresses) using forwarded register ports may be generated, and branch forwarding (e.g., immediate offset or a link register (LR)) may be performed. In one example, the decode stage 906 and the register read/memory read stage 914 may be combined into one pipeline stage. In one example, during the execute stage 916, the decoded instructions may be executed, LSU address/data pipelining to an Advanced Microcontroller Bus (AMB) interface may be performed, multiply and add operations may be performed, arithmetic operations with branch results may be performed, etc.

By way of example, the exemplary register renaming, out-of-order issue/execution architecture core of FIG. 9B may implement the pipeline 900 as follows: 1) the instruction fetch circuitry 938 performs the fetch and length decoding stages 902 and 904; 2) the decode circuitry 940 performs the decode stage 906; 3) the rename/allocator unit circuitry 952 performs the allocation stage 908 and renaming stage 910; 4) the scheduler(s) circuitry 956 performs the schedule stage 912; 5) the physical register file(s) circuitry 958 and the memory unit circuitry 970 perform the register read/memory read stage 914; the execution cluster(s) 960 perform the execute stage 916; 6) the memory unit circuitry 970 and the physical register file(s) circuitry 958 perform the write back/memory write stage 918; 7) various circuitry may be involved in the exception handling stage 922; and 8) the retirement unit circuitry 954 and the physical register file(s) circuitry 958 perform the commit stage 924.

FIG. 9B shows a processor core 990 including front-end unit circuitry 930 coupled to an execution engine unit circuitry 950, and both are coupled to a memory unit circuitry 970. The core 990 may be a reduced instruction set architecture computing (RISC) core, a complex instruction set architecture computing (CISC) core, a very long instruction word (VLIW) core, or a hybrid or alternative core type. As yet another option, the core 990 may be a special-purpose core, such as, for example, a network or communication core, compression engine, coprocessor core, general purpose computing graphics processing unit (GPGPU) core, graphics core, or the like.

The front end unit circuitry 930 may include branch prediction circuitry 932 coupled to an instruction cache circuitry 934, which is coupled to an instruction translation lookaside buffer (TLB) 936, which is coupled to instruction fetch circuitry 938, which is coupled to decode circuitry 940. In one example, the instruction cache circuitry 934 is included in the memory unit circuitry 970 rather than the front-end circuitry 930. The decode circuitry 940 (or decoder) may decode instructions, and generate as an output one or more micro-operations, micro-code entry points, microinstructions, other instructions, or other control signals, which are decoded from, or which otherwise reflect, or are derived from, the original instructions. The decode circuitry 940 may further include an address generation unit (AGU, not shown) circuitry. In one example, the AGU generates an LSU address using forwarded register ports, and may further perform branch forwarding (e.g., immediate offset branch forwarding, LR register branch forwarding, etc.). The decode circuitry 940 may be implemented using various different mechanisms. Examples of suitable mechanisms include, but are not limited to, look-up tables, hardware implementations, programmable logic arrays (PLAs), microcode read only memories (ROMs), etc. In one example, the core 990 includes a microcode ROM (not shown) or other medium that stores microcode for certain macroinstructions (e.g., in decode circuitry 940 or otherwise within the front end circuitry 930). In one example, the decode circuitry 940 includes a micro-operation (micro-op) or operation cache (not shown) to hold/cache decoded operations, micro-tags, or micro-operations generated during the decode or other stages of the processor pipeline 900. The decode circuitry 940 may be coupled to rename/allocator unit circuitry 952 in the execution engine circuitry 950.

The execution engine circuitry 950 includes the rename/allocator unit circuitry 952 coupled to a retirement unit circuitry 954 and a set of one or more scheduler(s) circuitry 956. The scheduler(s) circuitry 956 represents any number of different schedulers, including reservations stations, central instruction window, etc. In some examples, the scheduler(s) circuitry 956 can include arithmetic logic unit (ALU) scheduler/scheduling circuitry, ALU queues, arithmetic generation unit (AGU) scheduler/scheduling circuitry, AGU queues, etc. The scheduler(s) circuitry 956 is coupled to the physical register file(s) circuitry 958. Each of the physical register file(s) circuitry 958 represents one or more physical register files, different ones of which store one or more different data types, such as scalar integer, scalar floating-point, packed integer, packed floating-point, vector integer, vector floating-point, status (e.g., an instruction pointer that is the address of the next instruction to be executed), etc. In one example, the physical register file(s) circuitry 958 includes vector registers unit circuitry, writemask registers unit circuitry, and scalar register unit circuitry. These register units may provide architectural vector registers, vector mask registers, general-purpose registers, etc. The physical register file(s) circuitry 958 is coupled to the retirement unit circuitry 954 (also known as a retire queue or a retirement queue) to illustrate various ways in which register renaming and out-of-order execution may be implemented (e.g., using a reorder buffer(s) (ROB(s)) and a retirement register file(s); using a future file(s), a history buffer(s), and a retirement register file(s); using a register maps and a pool of registers; etc.). The retirement unit circuitry 954 and the physical register file(s) circuitry 958 are coupled to the execution cluster(s) 960. The execution cluster(s) 960 includes a set of one or more execution unit(s) circuitry 962 and a set of one or more memory access circuitry 964. The execution unit(s) circuitry 962 may perform various arithmetic, logic, floating-point or other types of operations (e.g., shifts, addition, subtraction, multiplication) and on various types of data (e.g., scalar integer, scalar floating-point, packed integer, packed floating-point, vector integer, vector floating-point). While some examples may include a number of execution units or execution unit circuitry dedicated to specific functions or sets of functions, other examples may include only one execution unit circuitry or multiple execution units/execution unit circuitry that all perform all functions. The scheduler(s) circuitry 956, physical register file(s) circuitry 958, and execution cluster(s) 960 are shown as being possibly plural because certain examples create separate pipelines for certain types of data/operations (e.g., a scalar integer pipeline, a scalar floating-point/packed integer/packed floating-point/vector integer/vector floating-point pipeline, and/or a memory access pipeline that each have their own scheduler circuitry, physical register file(s) circuitry, and/or execution cluster—and in the case of a separate memory access pipeline, certain examples are implemented in which only the execution cluster of this pipeline has the memory access unit(s) circuitry 964). It should also be understood that where separate pipelines are used, one or more of these pipelines may be out-of-order issue/execution and the rest in-order.

In some examples, the execution engine unit circuitry 950 may perform load store unit (LSU) address/data pipelining to an Advanced Microcontroller Bus (AMB) interface (not shown), and address phase and writeback, data phase load, store, and branches.

The set of memory access circuitry 964 is coupled to the memory unit circuitry 970, which includes data TLB circuitry 972 coupled to a data cache circuitry 974 coupled to a level 2 (L2) cache circuitry 976. In one exemplary example, the memory access circuitry 964 may include a load unit circuitry, a store address unit circuit, and a store data unit circuitry, each of which is coupled to the data TLB circuitry 972 in the memory unit circuitry 970. The instruction cache circuitry 934 is further coupled to the level 2 (L2) cache circuitry 976 in the memory unit circuitry 970. In one example, the instruction cache 934 and the data cache 974 are combined into a single instruction and data cache (not shown) in L2 cache circuitry 976, a level 3 (L3) cache circuitry (not shown), and/or main memory. The L2 cache circuitry 976 is coupled to one or more other levels of cache and eventually to a main memory.

The core 990 may support one or more instructions sets (e.g., the x86 instruction set architecture (optionally with some extensions that have been added with newer versions); the MIPS instruction set architecture; the ARM instruction set architecture (optionally with optional additional extensions such as NEON)), including the instruction(s) described herein. In one example, the core 990 includes logic to support a packed data instruction set architecture extension (e.g., AVX1, AVX2), thereby allowing the operations used by many multimedia applications to be performed using packed data.

### Exemplary Execution Unit(s) Circuitry.

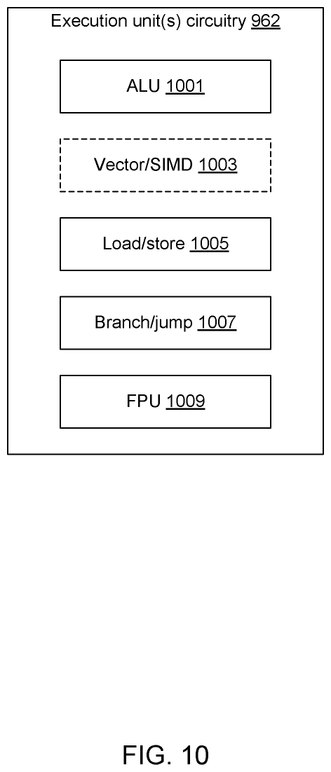

FIG. 10 illustrates examples of execution unit(s) circuitry, such as execution unit(s) circuitry 962 of FIG. 9B. As illustrated, execution unit(s) circuity 962 may include one or more ALU circuits 1001, optional vector/single instruction multiple data (SIMD) circuits 1003, load/store circuits 1005, branch/jump circuits 1007, and/or Floating-point unit (FPU) circuits 1009. ALU circuits 1001 perform integer arithmetic and/or Boolean operations. Vector/SIMD circuits 1003 perform vector/SIMD operations on packed data (such as SIMD/vector registers). Load/store circuits 1005 execute load and store instructions to load data from memory into registers or store from registers to memory. Load/store circuits 1005 may also generate addresses. Branch/jump circuits 1007 cause a branch or jump to a memory address depending on the instruction. FPU circuits 1009 perform floating-point arithmetic. The width of the execution unit(s) circuitry 962 varies depending upon the example and can range from 16-bit to 1,024-bit, for example. In some examples, two or more smaller execution units are logically combined to form a larger execution unit (e.g., two 128-bit execution units are logically combined to form a 256-bit execution unit).

### Exemplary Register Architecture

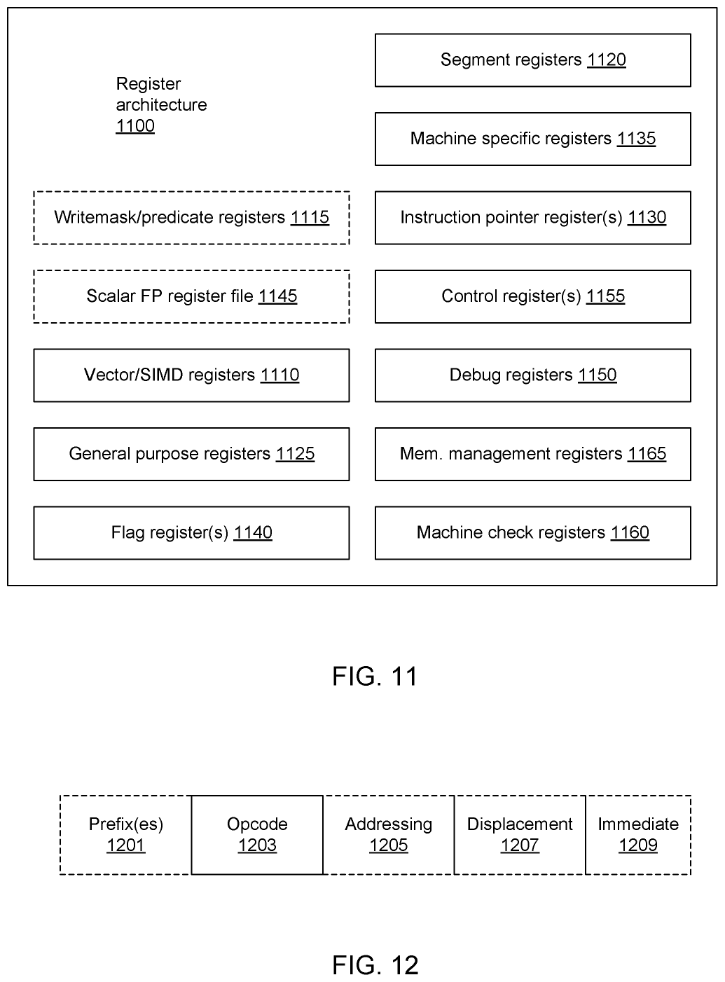

FIG. 11 is a block diagram of a register architecture 1100 according to some examples. As illustrated, the register architecture 1100 includes vector/SIMD registers 1110 that vary from 128-bit to 1,024 bits width. In some examples, the vector/SIMD registers 1110 are physically 512-bits and, depending upon the mapping, only some of the lower bits are used. For example, in some examples, the vector/SIMD registers 1110 are ZMM registers which are 512 bits: the lower 256 bits are used for YMM registers and the lower 128 bits are used for XMM registers. As such, there is an overlay of registers. In some examples, a vector length field selects between a maximum length and one or more other shorter lengths, where each such shorter length is half the length of the preceding length. Scalar operations are operations performed on the lowest order data element position in a ZMM/YMM/XMM register; the higher order data element positions are either left the same as they were prior to the instruction or zeroed depending on the example.

In some examples, the register architecture 1100 includes writemask/predicate registers 1115. For example, in some examples, there are 8 writemask/predicate registers (sometimes called k0 through k7) that are each 16-bit, 32-bit, 64-bit, or 128-bit in size. Writemask/predicate registers 1115 may allow for merging (e.g., allowing any set of elements in the destination to be protected from updates during the execution of any operation) and/or zeroing (e.g., zeroing vector masks allow any set of elements in the destination to be zeroed during the execution of any operation). In some examples, each data element position in a given writemask/predicate register 1115 corresponds to a data element position of the destination. In other examples, the writemask/predicate registers 1115 are scalable and consists of a set number of enable bits for a given vector element (e.g., 8 enable bits per 64-bit vector element).

The register architecture 1100 includes a plurality of general-purpose registers 1125. These registers may be 16-bit, 32-bit, 64-bit, etc. and can be used for scalar operations. In some examples, these registers are referenced by the names RAX, RBX, RCX, RDX, RBP, RSI, RDI, RSP, and R8 through R15.

In some examples, the register architecture 1100 includes scalar floating-point (FP) register 1145 which is used for scalar floating-point operations on 32/64/80-bit floating-point data using the x87 instruction set architecture extension or as MMX registers to perform operations on 64-bit packed integer data, as well as to hold operands for some operations performed between the MMX and XMM registers.

One or more flag registers 1140 (e.g., EFLAGS, RFLAGS, etc.) store status and control information for arithmetic, compare, and system operations. For example, the one or more flag registers 1140 may store condition code information such as carry, parity, auxiliary carry, zero, sign, and overflow. In some examples, the one or more flag registers 1140 are called program status and control registers.

Segment registers 1120 contain segment points for use in accessing memory. In some examples, these registers are referenced by the names CS, DS, SS, ES, FS, and GS.

Machine specific registers (MSRs) 1135 control and report on processor performance. Most MSRs 1135 handle system-related functions and are not accessible to an application program. Machine check registers 1160 consist of control, status, and error reporting MSRs that are used to detect and report on hardware errors.

One or more instruction pointer register(s) 1130 store an instruction pointer value. Control register(s) 1155 (e.g., CRO-CR4) determine the operating mode of a processor (e.g., processor 770, 780, 738, 715, and/or 800) and the characteristics of a currently executing task. Debug registers 1150 control and allow for the monitoring of a processor or core's debugging operations.

Memory (mem) management registers 1165 specify the locations of data structures used in protected mode memory management. These registers may include a GDTR, IDRT, task register, and a LDTR register.

Alternative examples may use wider or narrower registers. Additionally, alternative examples may use more, less, or different register files and registers. The register architecture 1100 may, for example, be used in physical register file(s) circuitry 958.

### Instruction Set Architectures

An instruction set architecture (ISA) may include one or more instruction formats. A given instruction format may define various fields (e.g., number of bits, location of bits) to specify, among other things, the operation to be performed (e.g., opcode) and the operand(s) on which that operation is to be performed and/or other data field(s) (e.g., mask). Some instruction formats are further broken down through the definition of instruction templates (or sub-formats). For example, the instruction templates of a given instruction format may be defined to have different subsets of the instruction format's fields (the included fields are typically in the same order, but at least some have different bit positions because there are less fields included) and/or defined to have a given field interpreted differently. Thus, each instruction of an ISA is expressed using a given instruction format (and, if defined, in a given one of the instruction templates of that instruction format) and includes fields for specifying the operation and the operands. For example, an exemplary ADD instruction has a specific opcode and an instruction format that includes an opcode field to specify that opcode and operand fields to select operands (source1/destination and source2); and an occurrence of this ADD instruction in an instruction stream will have specific contents in the operand fields that select specific operands. In addition, though the description below is made in the context of x86 ISA, it is within the knowledge of one skilled in the art to apply the teachings of the present disclosure in another ISA.

### Exemplary Instruction Formats.

Examples of the instruction(s) described herein may be embodied in different formats. Additionally, exemplary systems, architectures, and pipelines are detailed below. Examples of the instruction(s) may be executed on such systems, architectures, and pipelines, but are not limited to those detailed.

FIG. 12 illustrates examples of an instruction format. As illustrated, an instruction may include multiple components including, but not limited to, one or more fields for: one or more prefixes 1201, an opcode 1203, addressing information 1205 (e.g., register identifiers, memory addressing information, etc.), a displacement value 1207, and/or an immediate value 1209. Note that some instructions utilize some or all of the fields of the format whereas others may only use the field for the opcode 1203. In some examples, the order illustrated is the order in which these fields are to be encoded, however, it should be appreciated that in other examples these fields may be encoded in a different order, combined, etc.

The prefix(es) field(s) 1201, when used, modifies an instruction. In some examples, one or more prefixes are used to repeat string instructions (e.g., 0xF0, 0xF2, 0xF3, etc.), to provide section overrides (e.g., 0x2E, 0x36, 0x3E, 0x26, 0x64, 0x65, 0x2E, 0x3E, etc.), to perform bus lock operations, and/or to change operand (e.g., 0x66) and address sizes (e.g., 0x67). Certain instructions require a mandatory prefix (e.g., 0x66, 0xF2, 0xF3, etc.). Certain of these prefixes may be considered “legacy” prefixes. Other prefixes, one or more examples of which are detailed herein, indicate, and/or provide further capability, such as specifying particular registers, etc. The other prefixes typically follow the “legacy” prefixes.

The opcode field 1203 is used to at least partially define the operation to be performed upon a decoding of the instruction. In some examples, a primary opcode encoded in the opcode field 1203 is one, two, or three bytes in length. In other examples, a primary opcode can be a different length. An additional 3-bit opcode field is sometimes encoded in another field.

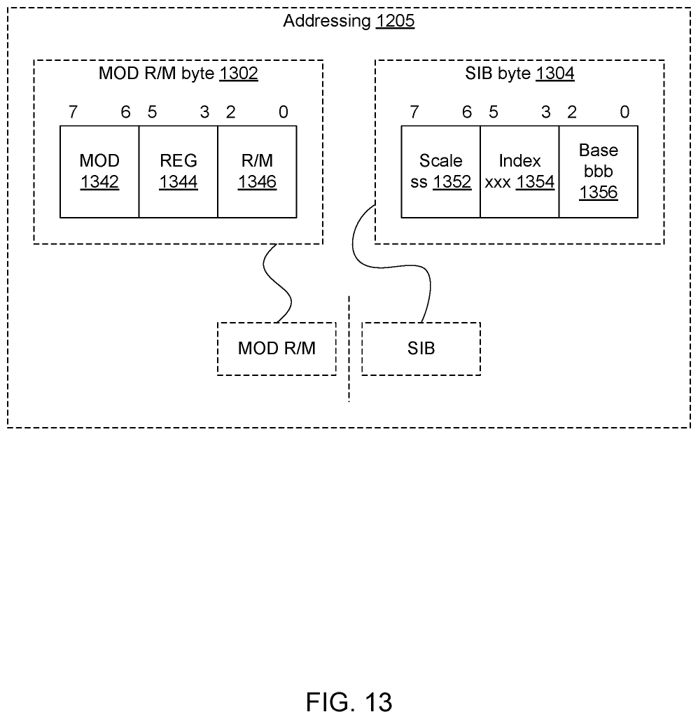

The addressing field 1205 is used to address one or more operands of the instruction, such as a location in memory or one or more registers. FIG. 13 illustrates examples of the addressing field 1205. In this illustration, an optional ModR/M byte 1302 and an optional Scale, Index, Base (SIB) byte 1304 are shown. The ModR/M byte 1302 and the SIB byte 1304 are used to encode up to two operands of an instruction, each of which is a direct register or effective memory address. Note that each of these fields are optional in that not all instructions include one or more of these fields. The MOD R/M byte 1302 includes a MOD field 1342, a register (reg) field 1344, and R/M field 1346.

The content of the MOD field 1342 distinguishes between memory access and non-memory access modes. In some examples, when the MOD field 1342 has a binary value of 11 (11b), a register-direct addressing mode is utilized, and otherwise register-indirect addressing is used.

The register field 1344 may encode either the destination register operand or a source register operand, or may encode an opcode extension and not be used to encode any instruction operand. The content of register index field 1344, directly or through address generation, specifies the locations of a source or destination operand (either in a register or in memory). In some examples, the register field 1344 is supplemented with an additional bit from a prefix (e.g., prefix 1201) to allow for greater addressing.

The R/M field 1346 may be used to encode an instruction operand that references a memory address or may be used to encode either the destination register operand or a source register operand. Note the R/M field 1346 may be combined with the MOD field 1342 to dictate an addressing mode in some examples.

The SIB byte 1304 includes a scale field 1352, an index field 1354, and a base field 1356 to be used in the generation of an address. The scale field 1352 indicates scaling factor. The index field 1354 specifies an index register to use. In some examples, the index field 1354 is supplemented with an additional bit from a prefix (e.g., prefix 1201) to allow for greater addressing. The base field 1356 specifies a base register to use. In some examples, the base field 1356 is supplemented with an additional bit from a prefix (e.g., prefix 1201) to allow for greater addressing. In practice, the content of the scale field 1352 allows for the scaling of the content of the index field 1354 for memory address generation (e.g., for address generation that uses 2scale*index+base).

Some addressing forms utilize a displacement value to generate a memory address. For example, a memory address may be generated according to 2scale*index+base+displacement, index*scale+displacement, r/m+displacement, instruction pointer (RIP/EIP)+displacement, register+displacement, etc. The displacement may be a 1-byte, 2-byte, 4-byte, etc. value. In some examples, a displacement 1207 provides this value. Additionally, in some examples, a displacement factor usage is encoded in the MOD field of the addressing field 1205 that indicates a compressed displacement scheme for which a displacement value is calculated and stored in the displacement field 1207.

In some examples, an immediate field 1209 specifies an immediate value for the instruction. An immediate value may be encoded as a 1-byte value, a 2-byte value, a 4-byte value, etc.

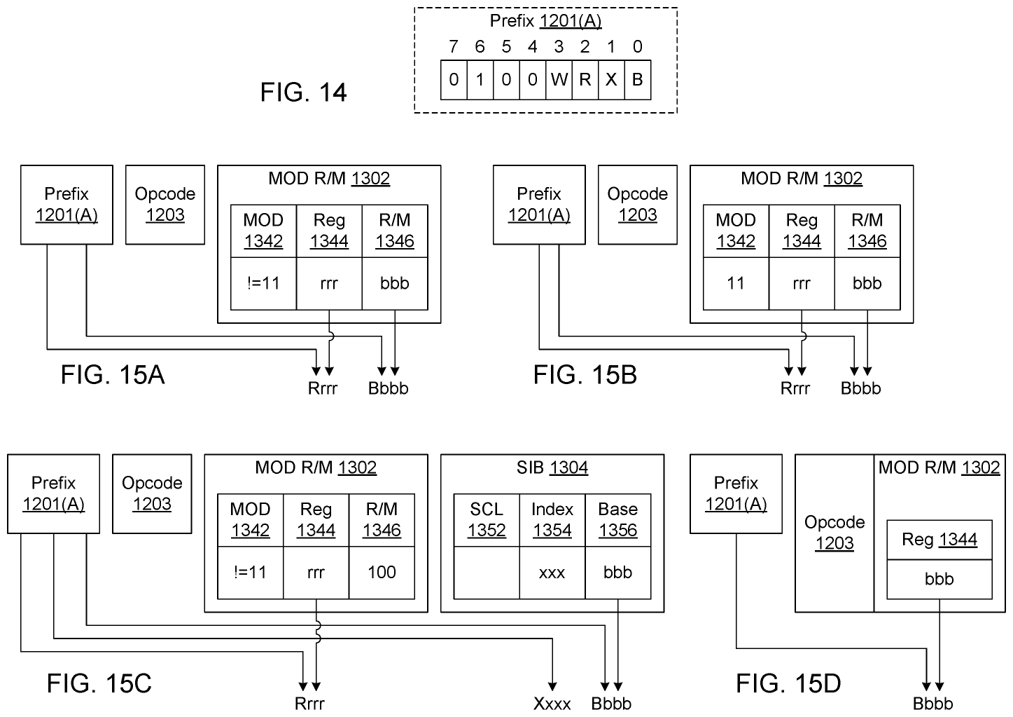

FIG. 14 illustrates examples of a first prefix 1201(A). In some examples, the first prefix 1201(A) is an example of a REX prefix. Instructions that use this prefix may specify general purpose registers, 64-bit packed data registers (e.g., single instruction, multiple data (SIMD) registers or vector registers), and/or control registers and debug registers (e.g., CR8-CR15 and DR8-DR15).

Instructions using the first prefix 1201(A) may specify up to three registers using 3-bit fields depending on the format: 1) using the reg field 1344 and the R/M field 1346 of the Mod R/M byte 1302; 2) using the Mod R/M byte 1302 with the SIB byte 1304 including using the reg field 1344 and the base field 1356 and index field 1354; or 3) using the register field of an opcode.

In the first prefix 1201(A), bit positions 7:4 are set as 0100. Bit position 3 (W) can be used to determine the operand size but may not solely determine operand width. As such, when W=0, the operand size is determined by a code segment descriptor (CS.D) and when W=1, the operand size is 64-bit.

Note that the addition of another bit allows for 16 (24) registers to be addressed, whereas the MOD R/M reg field 1344 and MOD R/M R/M field 1346 alone can each only address 8 registers.

In the first prefix 1201(A), bit position 2 (R) may be an extension of the MOD R/M reg field 1344 and may be used to modify the ModR/M reg field 1344 when that field encodes a general-purpose register, a 64-bit packed data register (e.g., a SSE register), or a control or debug register. R is ignored when Mod R/M byte 1302 specifies other registers or defines an extended opcode.

Bit position 1 (X) may modify the SIB byte index field 1354.

Bit position 0 (B) may modify the base in the Mod R/M R/M field 1346 or the SIB byte base field 1356; or it may modify the opcode register field used for accessing general purpose registers (e.g., general purpose registers 1125).

FIGS. 15A-D illustrate examples of how the R, X, and B fields of the first prefix 1201(A) are used. FIG. 15A illustrates R and B from the first prefix 1201(A) being used to extend the reg field 1344 and R/M field 1346 of the MOD R/M byte 1302 when the SIB byte 13 04 is not used for memory addressing. FIG. 15B illustrates R and B from the first prefix 1201(A) being used to extend the reg field 1344 and R/M field 1346 of the MOD R/M byte 1302 when the SIB byte 13 04 is not used (register-register addressing). FIG. 15C illustrates R, X, and B from the first prefix 1201(A) being used to extend the reg field 1344 of the MOD R/M byte 1302 and the index field 1354 and base field 1356 when the SIB byte 1304 being used for memory addressing. FIG. 15D illustrates B from the first prefix 1201(A) being used to extend the reg field 1344 of the MOD R/M byte 1302 when a register is encoded in the opcode 1203.

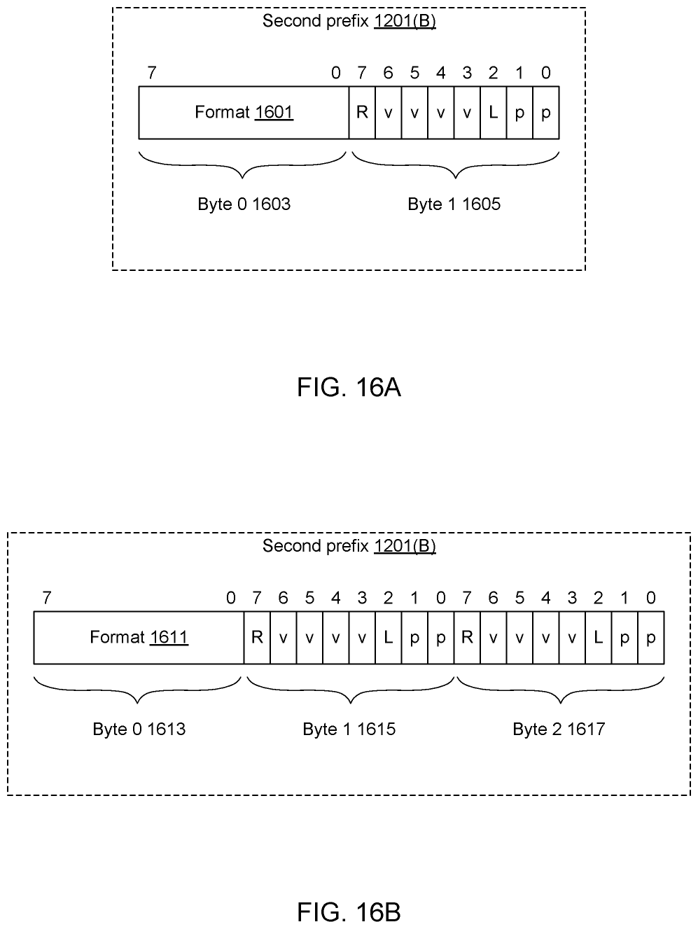

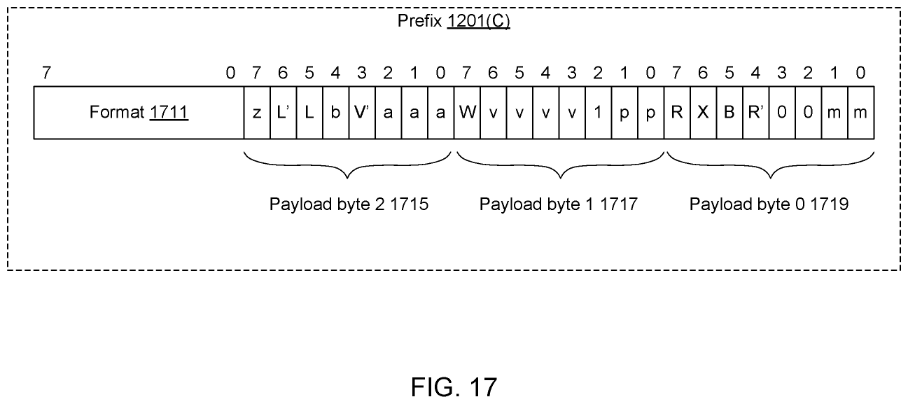

FIGS. 16A-B illustrate examples of a second prefix 1201(B). In some examples, the second prefix 1201(B) is an example of a VEX prefix. The second prefix 1201(B) encoding allows instructions to have more than two operands, and allows SIMD vector registers (e.g., vector/SIMD registers 1110) to be longer than 64-bits (e.g., 128-bit and 256-bit). The use of the second prefix 1201(B) provides for three-operand (or more) syntax. For example, previous two-operand instructions performed operations such as A=A+B, which overwrites a source operand. The use of the second prefix 1201(B) enables operands to perform nondestructive operations such as A=B+C.

In some examples, the second prefix 1201(B) comes in two forms—a two-byte form and a three-byte form. The two-byte second prefix 1201(B) is used mainly for 128-bit, scalar, and some 256-bit instructions; while the three-byte second prefix 1201(B) provides a compact replacement of the first prefix 1201(A) and 3-byte opcode instructions.

FIG. 16A illustrates examples of a two-byte form of the second prefix 1201(B). In one example, a format field 1601 (byte 0 1603) contains the value CSH. In one example, byte 1 1605 includes a “R” value in bit[7]. This value is the complement of the “R” value of the first prefix 1201(A). Bit[2] is used to dictate the length (L) of the vector (where a value of 0 is a scalar or 128-bit vector and a value of 1 is a 256-bit vector). Bits[1:0] provide opcode extensionality equivalent to some legacy prefixes (e.g., 00=no prefix, 01=66H, 10=F3H, and 11=F2H). Bits[6:3] shown as vvvv may be used to: 1) encode the first source register operand, specified in inverted (1s complement) form and valid for instructions with 2 or more source operands; 2) encode the destination register operand, specified in 1s complement form for certain vector shifts; or 3) not encode any operand, the field is reserved and should contain a certain value, such as 1111b.

Instructions that use this prefix may use the Mod R/M R/M field 1346 to encode the instruction operand that references a memory address or encode either the destination register operand or a source register operand.

Instructions that use this prefix may use the Mod R/M reg field 1344 to encode either the destination register operand or a source register operand, be treated as an opcode extension and not used to encode any instruction operand.

For instruction syntax that support four operands, vvvv, the Mod R/M R/M field 1346 and the Mod R/M reg field 1344 encode three of the four operands. Bits[7:4] of the immediate 1209 are then used to encode the third source register operand.

FIG. 16B illustrates examples of a three-byte form of the second prefix 1201(B). In one example, a format field 1611 (byte 0 1613) contains the value C4H. Byte 1 1615 includes in bits[7:5] “R,” “X,” and “B” which are the complements of the same values of the first prefix 1201(A). Bits[4:0] of byte 1 1615 (shown as mmmmm) include content to encode, as need, one or more implied leading opcode bytes. For example, 00001 implies a OFH leading opcode, 00010 implies a 0F38H leading opcode, 00011 implies a leading 0F3AH opcode, etc.

Bit[7] of byte 2 1617 is used similar to W of the first prefix 1201(A) including helping to determine promotable operand sizes. Bit[2] is used to dictate the length (L) of the vector (where a value of 0 is a scalar or 128-bit vector and a value of 1 is a 256-bit vector). Bits[1:0] provide opcode extensionality equivalent to some legacy prefixes (e.g., 00=no prefix, 01=66H, 10=F3H, and 11=F2H). Bits[6:3], shown as vvvv, may be used to: 1) encode the first source register operand, specified in inverted (1s complement) form and valid for instructions with 2 or more source operands; 2) encode the destination register operand, specified in is complement form for certain vector shifts; or 3) not encode any operand, the field is reserved and should contain a certain value, such as 1111b.

Instructions that use this prefix may use the Mod R/M R/M field 1346 to encode the instruction operand that references a memory address or encode either the destination register operand or a source register operand.

Instructions that use this prefix may use the Mod R/M reg field 1344 to encode either the destination register operand or a source register operand, be treated as an opcode extension and not used to encode any instruction operand.

For instruction syntax that support four operands, vvvv, the Mod R/M R/M field 1346, and the Mod R/M reg field 1344 encode three of the four operands. Bits[7:4] of the immediate 1209 are then used to encode the third source register operand.

FIG. 17 illustrates examples of a third prefix 1201(C). In some examples, the first prefix 1201(A) is an example of an EVEX prefix. The third prefix 1201(C) is a four-byte prefix.

The third prefix 1201(C) can encode 32 vector registers (e.g., 128-bit, 256-bit, and 512-bit registers) in 64-bit mode. In some examples, instructions that utilize a writemask/opmask (see discussion of registers in a previous figure, such as FIG. 11) or predication utilize this prefix. Opmask register allow for conditional processing or selection control. Opmask instructions, whose source/destination operands are opmask registers and treat the content of an opmask register as a single value, are encoded using the second prefix 1201(B).

The third prefix 1201(C) may encode functionality that is specific to instruction classes (e.g., a packed instruction with “load+op” semantic can support embedded broadcast functionality, a floating-point instruction with rounding semantic can support static rounding functionality, a floating-point instruction with non-rounding arithmetic semantic can support “suppress all exceptions” functionality, etc.).

The first byte of the third prefix 1201(C) is a format field 1711 that has a value, in one example, of 62H. Subsequent bytes are referred to as payload bytes 1715-1719 and collectively form a 24-bit value of P[23:0] providing specific capability in the form of one or more fields (detailed herein).

In some examples, P[1:0] of payload byte 1719 are identical to the low two mmmmm bits. P[3:2] are reserved in some examples. Bit P[4] (R′) allows access to the high 16 vector register set when combined with P[7] and the ModR/M reg field 1344. P[6] can also provide access to a high 16 vector register when SIB-type addressing is not needed. P[7:5] consist of an R, X, and B which are operand specifier modifier bits for vector register, general purpose register, memory addressing and allow access to the next set of 8 registers beyond the low 8 registers when combined with the ModR/M register field 1344 and ModR/M R/M field 1346. P[9:8] provide opcode extensionality equivalent to some legacy prefixes (e.g., 00=no prefix, 01=66H, 10=F3H, and 11=F2H). P[10] in some examples is a fixed value of 1. P[14:11], shown as vvvv, may be used to: 1) encode the first source register operand, specified in inverted (ls complement) form and valid for instructions with 2 or more source operands; 2) encode the destination register operand, specified in is complement form for certain vector shifts; or 3) not encode any operand, the field is reserved and should contain a certain value, such as 1111b.

P[15] is similar to W of the first prefix 1201(A) and second prefix 1211(B) and may serve as an opcode extension bit or operand size promotion.

P[18:16] specify the index of a register in the opmask (writemask) registers (e.g., writemask/predicate registers 1115). In one example, the specific value aaa=000 has a special behavior implying no opmask is used for the particular instruction (this may be implemented in a variety of ways including the use of a opmask hardwired to all ones or hardware that bypasses the masking hardware). When merging, vector masks allow any set of elements in the destination to be protected from updates during the execution of any operation (specified by the base operation and the augmentation operation); in other one example, preserving the old value of each element of the destination where the corresponding mask bit has a 0. In contrast, when zeroing vector masks allow any set of elements in the destination to be zeroed during the execution of any operation (specified by the base operation and the augmentation operation); in one example, an element of the destination is set to 0 when the corresponding mask bit has a 0 value. A subset of this functionality is the ability to control the vector length of the operation being performed (that is, the span of elements being modified, from the first to the last one); however, it is not necessary that the elements that are modified be consecutive. Thus, the opmask field allows for partial vector operations, including loads, stores, arithmetic, logical, etc. While examples are described in which the opmask field's content selects one of a number of opmask registers that contains the opmask to be used (and thus the opmask field's content indirectly identifies that masking to be performed), alternative examples instead or additional allow the mask write field's content to directly specify the masking to be performed.

P[19] can be combined with P[14:11] to encode a second source vector register in a non-destructive source syntax which can access an upper 16 vector registers using P[19]. P[20] encodes multiple functionalities, which differs across different classes of instructions and can affect the meaning of the vector length/rounding control specifier field (P[22:21]). P[23] indicates support for merging-writemasking (e.g., when set to 0) or support for zeroing and merging-writemasking (e.g., when set to 1).

Exemplary examples of encoding of registers in instructions using the third prefix 1201(C) are detailed in the following tables.

TABLE 1
32-Register Support in 64-bit Mode

| | 4 | 3 | [2:0] | REG. TYPE | COMMON USAGES |
|---|---|---|---|---|---|
| REG | R′ | R | ModR/M | GPR, Vector | Destination or Source |
| | | | reg | | |
| VVVV | V′ | vvvv | | GPR, Vector | 2nd Source or Destination |
| RM | X | B | ModR/M | GPR, Vector | 1st Source or Destination |
| | | | R/M | | |
| BASE | 0 | B | ModR/M | GPR | Memory addressing |
| | | | R/M | | |
| INDEX | 0 | X | SIB.index | GPR | Memory addressing |
| VIDX | V′ | X | SIB.index | Vector | VSIB memory addressing |

TABLE 2
Encoding Register Specifiers in 32-bit Mode

| | [2:0] | REG. TYPE | COMMON USAGES |
|---|---|---|---|
| REG | ModR/M reg | GPR, Vector | Destination or Source |
| VVVV | vvvv | GPR, Vector | 2nd Source or Destination |
| RM | ModR/M R/M | GPR, Vector | 1st Source or Destination |
| BASE | ModR/M R/M | GPR | Memory addressing |
| INDEX | SIB.index | GPR | Memory addressing |
| VIDX | SIB.index | Vector | VSIB memory addressing |

TABLE 3
Opmask Register Specifier Encoding

| | [2:0] | REG. TYPE | COMMON USAGES |
|---|---|---|---|
| REG | ModR/M Reg | k0-k7 | Source |
| VVVV | vvvv | k0-k7 | 2nd Source |
| RM | ModR/M R/M | k0-k7 | 1st Source |
| {k1] | aaa | k0-k7 | Opmask |

Program code may be applied to input information to perform the functions described herein and generate output information. The output information may be applied to one or more output devices, in known fashion. For purposes of this application, a processing system includes any system that has a processor, such as, for example, a digital signal processor (DSP), a microcontroller, an application specific integrated circuit (ASIC), a field programmable gate array (FPGA), a microprocessor, or any combination thereof.

The program code may be implemented in a high-level procedural or object-oriented programming language to communicate with a processing system. The program code may also be implemented in assembly or machine language, if desired. In fact, the mechanisms described herein are not limited in scope to any particular programming language. In any case, the language may be a compiled or interpreted language.

Examples of the mechanisms disclosed herein may be implemented in hardware, software, firmware, or a combination of such implementation approaches. Examples may be implemented as computer programs or program code executing on programmable systems comprising at least one processor, a storage system (including volatile and non-volatile memory and/or storage elements), at least one input device, and at least one output device.

One or more aspects of at least one example may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), phase change memory (PCM), magnetic or optical cards, or any other type of media suitable for storing electronic instructions.

Accordingly, examples also include non-transitory, tangible machine-readable media containing instructions or containing design data, such as Hardware Description Language (HDL), which defines structures, circuits, apparatuses, processors and/or system features described herein. Such examples may also be referred to as program products.

### Emulation (Including Binary Translation, Code Morphing, etc.).

In some cases, an instruction converter may be used to convert an instruction from a source instruction set architecture to a target instruction set architecture. For example, the instruction converter may translate (e.g., using static binary translation, dynamic binary translation including dynamic compilation), morph, emulate, or otherwise convert an instruction to one or more other instructions to be processed by the core. The instruction converter may be implemented in software, hardware, firmware, or a combination thereof. The instruction converter may be on processor, off processor, or part on and part off processor.

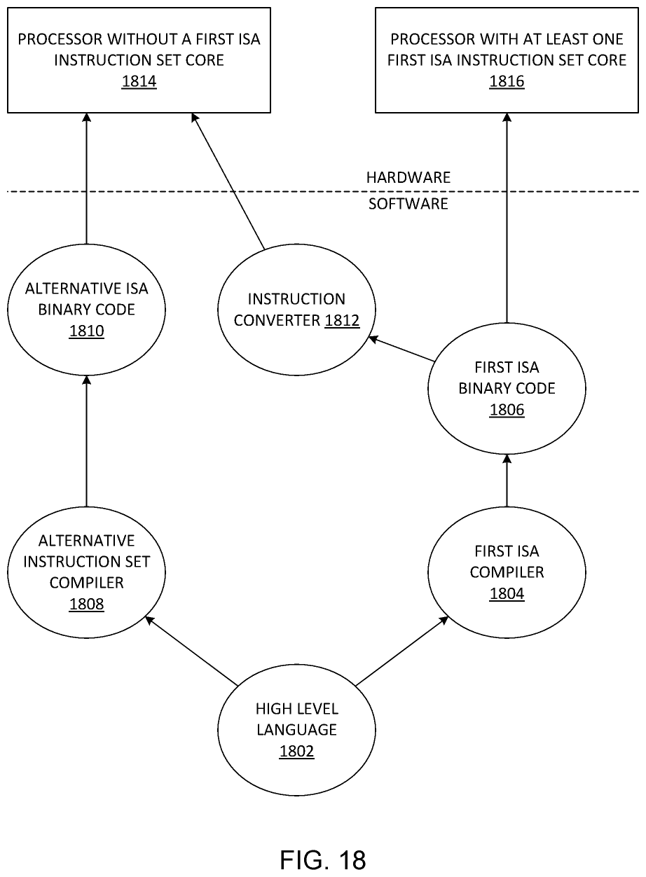

FIG. 18 illustrates a block diagram contrasting the use of a software instruction converter to convert binary instructions in a source instruction set architecture to binary instructions in a target instruction set architecture according to examples. In the illustrated example, the instruction converter is a software instruction converter, although alternatively the instruction converter may be implemented in software, firmware, hardware, or various combinations thereof. FIG. 18 shows a program in a high-level language 1802 may be compiled using a first ISA compiler 1804 to generate first ISA binary code 1806 that may be natively executed by a processor with at least one first instruction set architecture core 1816. The processor with at least one first ISA instruction set architecture core 1816 represents any processor that can perform substantially the same functions as an Intel® processor with at least one first ISA instruction set architecture core by compatibly executing or otherwise processing (1) a substantial portion of the instruction set architecture of the first ISA instruction set architecture core or (2) object code versions of applications or other software targeted to run on an Intel processor with at least one first ISA instruction set architecture core, in order to achieve substantially the same result as a processor with at least one first ISA instruction set architecture core. The first ISA compiler 1804 represents a compiler that is operable to generate first ISA binary code 1806 (e.g., object code) that can, with or without additional linkage processing, be executed on the processor with at least one first ISA instruction set architecture core 1816. Similarly, FIG. 18 shows the program in the high-level language 1802 may be compiled using an alternative instruction set architecture compiler 1808 to generate alternative instruction set architecture binary code 1810 that may be natively executed by a processor without a first ISA instruction set architecture core 1814. The instruction converter 1812 is used to convert the first ISA binary code 1806 into code that may be natively executed by the processor without a first ISA instruction set architecture core 1814. This converted code is not necessarily to be the same as the alternative instruction set architecture binary code 1810; however, the converted code will accomplish the general operation and be made up of instructions from the alternative instruction set architecture. Thus, the instruction converter 1812 represents software, firmware, hardware, or a combination thereof that, through emulation, simulation or any other process, allows a processor or other electronic device that does not have a first ISA instruction set architecture processor or core to execute the first ISA binary code 1806.

### Examples Section

In one or more first embodiments, an integrated circuit comprises first circuitry to receive a first message which indicates a first address which corresponds to a first line of data, and identify a first location of a preliminary cache based on the message, second circuitry coupled to the first circuitry, wherein, based on the first message, the second circuitry is to identify a second location of a victim cache, comprising the second circuitry to perform a calculation based on one of an encryption key or a hash function, move a second line from the first location to the second location, and store the first line to the first location.

In one or more second embodiments, further to the first embodiment, the second circuitry to identify the second location comprises the second circuitry to determine, based on the calculation, an index of a set of the victim cache.

In one or more third embodiments, further to the first embodiment or the second embodiment, the primary cache comprises a skewed cache.

In one or more fourth embodiments, further to any of the first through third embodiments, the first circuitry is further to receive a second message which indicates a second address which corresponds to the second line, and wherein the second circuitry is further to move the second line from the second location to the preliminary cache based on the second message.

In one or more fifth embodiments, further to the fourth embodiment, the second circuitry to move the second line from the second location to the preliminary cache comprises the second circuitry to swap the second line and a third line between the preliminary cache and the victim cache.

In one or more sixth embodiments, further to the fifth embodiment, the second line and the third line are swapped based on a valid state of the third line.

In one or more seventh embodiments, further to the fourth embodiment, based on the first message, the second circuitry is further to evict a third line from the second location to a memory before the second circuitry is to move the second line from the first location to the second location.

In one or more eighth embodiments, further to the seventh embodiment, the second circuitry is to evict the third line based on a valid state of the third line.

In one or more ninth embodiments, further to the fourth embodiment, the second circuitry is to move the second line to the second location based on a valid state of the second line.

In one or more tenth embodiments, a method at a processor comprises receiving a first message which indicates a first address which corresponds to a first line of data, identifying a first location of a preliminary cache based on the message, based on the first message identifying a second location of a victim cache, comprising performing a calculation based on one of an encryption key or a hash function, moving a second line from the first location to the second location, and storing the first line to the first location.

In one or more eleventh embodiments, further to the tenth embodiment, identifying the second location comprises determining, based on the calculation, an index of a set of the victim cache.

In one or more twelfth embodiments, further to the tenth embodiment or the eleventh embodiment, the primary cache comprises a skewed cache.

In one or more thirteenth embodiments, further to any of the tenth through twelfth embodiments, the method further comprises receiving a second message which indicates a second address which corresponds to the second line, and moving the second line from the second location to the preliminary cache based on the second message.

In one or more fourteenth embodiments, further to the thirteenth embodiment, moving the second line from the second location to the preliminary cache comprises swapping the second line and a third line between the preliminary cache and the victim cache.

In one or more fifteenth embodiments, further to the fourteenth embodiment, the second line and the third line are swapped based on a valid state of the third line.

In one or more sixteenth embodiments, further to the thirteenth embodiment, the method further comprises based on the first message, evicting a third line from the second location to a memory before the the second line is moved from the first location to the second location.

In one or more seventeenth embodiments, further to the sixteenth embodiment, the third line is evicted based on a valid state of the third line.

In one or more eighteenth embodiments, further to the thirteenth embodiment, the second line is moved to the second location based on a valid state of the second line.

In one or more nineteenth embodiments, a system comprises an integrated circuit (IC) chip comprising first circuitry to receive a first message which indicates a first address which corresponds to a first line of data, and identify a first location of a preliminary cache based on the message, second circuitry coupled to the first circuitry, wherein, based on the first message, the second circuitry is to identify a second location of a victim cache, comprising the second circuitry to perform a calculation based on one of an encryption key or a hash function, move a second line from the first location to the second location, and store the first line to the first location, and a display device coupled to the IC chip, the display device to display an image based on a signal communicated with the IC chip.

In one or more twentieth embodiments, further to the nineteenth embodiment, the second circuitry to identify the second location comprises the second circuitry to determine, based on the calculation, an index of a set of the victim cache.

In one or more twenty-first embodiments, further to the nineteenth embodiment or the twentieth embodiment, the primary cache comprises a skewed cache.

In one or more twenty-second embodiments, further to any of the nineteenth through twenty-first embodiments, the first circuitry is further to receive a second message which indicates a second address which corresponds to the second line, and wherein the second circuitry is further to move the second line from the second location to the preliminary cache based on the second message.

In one or more twenty-third embodiments, further to the twenty-second embodiment, the second circuitry to move the second line from the second location to the preliminary cache comprises the second circuitry to swap the second line and a third line between the preliminary cache and the victim cache.

In one or more twenty-fourth embodiments, further to the twenty-third embodiment, the second line and the third line are swapped based on a valid state of the third line.

In one or more twenty-fifth embodiments, further to the twenty-second embodiment, based on the first message, the second circuitry is further to evict a third line from the second location to a memory before the second circuitry is to move the second line from the first location to the second location.

In one or more twenty-sixth embodiments, further to the twenty-fifth embodiment, the second circuitry is to evict the third line based on a valid state of the third line.

In one or more twenty-seventh embodiments, further to the twenty-second embodiment, the second circuitry is to move the second line to the second location based on a valid state of the second line.

Numerous details are described herein to provide a more thorough explanation of the embodiments of the present disclosure. It will be apparent to one skilled in the art, however, that embodiments of the present disclosure may be practiced without these specific details. In other instances, well-known structures and devices are shown in block diagram form, rather than in detail, in order to avoid obscuring embodiments of the present disclosure.

Note that in the corresponding drawings of the embodiments, signals are represented with lines. Some lines may be thicker, to indicate a greater number of constituent signal paths, and/or have arrows at one or more ends, to indicate a direction of information flow. Such indications are not intended to be limiting. Rather, the lines are used in connection with one or more exemplary embodiments to facilitate easier understanding of a circuit or a logical unit. Any represented signal, as dictated by design needs or preferences, may actually comprise one or more signals that may travel in either direction and may be implemented with any suitable type of signal scheme.

Throughout the specification, and in the claims, the term “connected” means a direct connection, such as electrical, mechanical, or magnetic connection between the things that are connected, without any intermediary devices. The term “coupled” means a direct or indirect connection, such as a direct electrical, mechanical, or magnetic connection between the things that are connected or an indirect connection, through one or more passive or active intermediary devices. The term “circuit” or “module” may refer to one or more passive and/or active components that are arranged to cooperate with one another to provide a desired function. The term “signal” may refer to at least one current signal, voltage signal, magnetic signal, or data/clock signal. The meaning of “a,” “an,” and “the” include plural references. The meaning of “in” includes “in” and “on.”

The term “device” may generally refer to an apparatus according to the context of the usage of that term. For example, a device may refer to a stack of layers or structures, a single structure or layer, a connection of various structures having active and/or passive elements, etc. Generally, a device is a three-dimensional structure with a plane along the x-y direction and a height along the z direction of an x-y-z Cartesian coordinate system. The plane of the device may also be the plane of an apparatus which comprises the device.

The term “scaling” generally refers to converting a design (schematic and layout) from one process technology to another process technology and subsequently being reduced in layout area. The term “scaling” generally also refers to downsizing layout and devices within the same technology node. The term “scaling” may also refer to adjusting (e.g., slowing down or speeding up—i.e. scaling down, or scaling up respectively) of a signal frequency relative to another parameter, for example, power supply level.

The terms “substantially,” “close,” “approximately,” “near,” and “about,” generally refer to being within +/−10% of a target value. For example, unless otherwise specified in the explicit context of their use, the terms “substantially equal,” “about equal” and “approximately equal” mean that there is no more than incidental variation between among things so described. In the art, such variation is typically no more than +/−10% of a predetermined target value.

It is to be understood that the terms so used are interchangeable under appropriate circumstances such that the embodiments of the invention described herein are, for example, capable of operation in other orientations than those illustrated or otherwise described herein.

Unless otherwise specified the use of the ordinal adjectives “first,” “second,” and “third,” etc., to describe a common object, merely indicate that different instances of like objects are being referred to and are not intended to imply that the objects so described must be in a given sequence, either temporally, spatially, in ranking or in any other manner.

The terms “left,” “right,” “front,” “back,” “top,” “bottom,” “over,” “under,” and the like in the description and in the claims, if any, are used for descriptive purposes and not necessarily for describing permanent relative positions. For example, the terms “over,” “under,” “front side,” “back side,” “top,” “bottom,” “over,” “under,” and “on” as used herein refer to a relative position of one component, structure, or material with respect to other referenced components, structures or materials within a device, where such physical relationships are noteworthy. These terms are employed herein for descriptive purposes only and predominantly within the context of a device z-axis and therefore may be relative to an orientation of a device. Hence, a first material “over” a second material in the context of a figure provided herein may also be “under” the second material if the device is oriented upside-down relative to the context of the figure provided. In the context of materials, one material disposed over or under another may be directly in contact or may have one or more intervening materials. Moreover, one material disposed between two materials may be directly in contact with the two layers or may have one or more intervening layers. In contrast, a first material “on” a second material is in direct contact with that second material. Similar distinctions are to be made in the context of component assemblies.

The term “between” may be employed in the context of the z-axis, x-axis or y-axis of a device. A material that is between two other materials may be in contact with one or both of those materials, or it may be separated from both of the other two materials by one or more intervening materials. A material “between” two other materials may therefore be in contact with either of the other two materials, or it may be coupled to the other two materials through an intervening material. A device that is between two other devices may be directly connected to one or both of those devices, or it may be separated from both of the other two devices by one or more intervening devices.

As used throughout this description, and in the claims, a list of items joined by the term “at least one of” or “one or more of” can mean any combination of the listed terms. For example, the phrase “at least one of A, B or C” can mean A; B; C; A and B; A and C; B and C; or A, B and C. It is pointed out that those elements of a figure having the same reference numbers (or names) as the elements of any other figure can operate or function in any manner similar to that described, but are not limited to such.

In addition, the various elements of combinatorial logic and sequential logic discussed in the present disclosure may pertain both to physical structures (such as AND gates, OR gates, or XOR gates), or to synthesized or otherwise optimized collections of devices implementing the logical structures that are Boolean equivalents of the logic under discussion.

Techniques and architectures for operating a cache are described herein. In the above description, for purposes of explanation, numerous specific details are set forth in order to provide a thorough understanding of certain embodiments. It will be apparent, however, to one skilled in the art that certain embodiments can be practiced without these specific details. In other instances, structures and devices are shown in block diagram form in order to avoid obscuring the description.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

Some portions of the detailed description herein are presented in terms of algorithms and symbolic representations of operations on data bits within a computer memory. These algorithmic descriptions and representations are the means used by those skilled in the computing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the discussion herein, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Certain embodiments also relate to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs) such as dynamic RAM (DRAM), EPROMs, EEPROMs, magnetic or optical cards, or any type of media suitable for storing electronic instructions, and coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description herein. In addition, certain embodiments are not described with reference to any particular programming language. It will be appreciated that a variety of programming languages may be used to implement the teachings of such embodiments as described herein.

Besides what is described herein, various modifications may be made to the disclosed embodiments and implementations thereof without departing from their scope. Therefore, the illustrations and examples herein should be construed in an illustrative, and not a restrictive sense. The scope of the invention should be measured solely by reference to the claims that follow.

What is claimed is:

1. An integrated circuit comprising:
first circuitry to:
receive a first message which indicates a first address which corresponds to a first line of data; and
identify a first location of a preliminary cache based on the message;
second circuitry coupled to the first circuitry, wherein, based on the first message, the second circuitry is to:
identify a second location of a victim cache, comprising the second circuitry to perform a calculation based on one of an encryption key or a hash function;
move a second line from the first location to the second location; and
store the first line to the first location.

2. The integrated circuit of claim 1, wherein the second circuitry to identify the second location comprises the second circuitry to determine, based on the calculation, an index of a set of the victim cache.

3. The integrated circuit of claim 1, wherein the primary cache comprises a skewed cache.

4. The integrated circuit of claim 1, wherein the first circuitry is further to receive a second message which indicates a second address which corresponds to the second line; and
wherein the second circuitry is further to move the second line from the second location to the preliminary cache based on the second message.

5. The integrated circuit of claim 4, wherein the second circuitry to move the second line from the second location to the preliminary cache comprises the second circuitry to swap the second line and a third line between the preliminary cache and the victim cache.

6. The integrated circuit of claim 5, wherein the second line and the third line are swapped based on a valid state of the third line.

7. The integrated circuit of claim 4, wherein, based on the first message, the second circuitry is further to evict a third line from the second location to a memory before the second circuitry is to move the second line from the first location to the second location.

8. The integrated circuit of claim 7, wherein the second circuitry is to evict the third line based on a valid state of the third line.

9. The integrated circuit of claim 4, wherein the second circuitry is to move the second line to the second location based on a valid state of the second line.

10. A method at a processor, the method comprising:
receiving a first message which indicates a first address which corresponds to a first line of data;
identifying a first location of a preliminary cache based on the message;
based on the first message:
identifying a second location of a victim cache, comprising performing a calculation based on one of an encryption key or a hash function;
moving a second line from the first location to the second location; and
storing the first line to the first location.

11. The method of claim 10, wherein identifying the second location comprises determining, based on the calculation, an index of a set of the victim cache.

12. The method of claim 10, wherein the primary cache comprises a skewed cache.

13. The method of claim 10, further comprising:
receiving a second message which indicates a second address which corresponds to the second line; and
moving the second line from the second location to the preliminary cache based on the second message.

14. The method of claim 13, wherein moving the second line from the second location to the preliminary cache comprises swapping the second line and a third line between the preliminary cache and the victim cache.

15. The method of claim 13, further comprising:
based on the first message, evicting a third line from the second location to a memory before the second line is moved from the first location to the second location.

16. A system comprising:
an integrated circuit (IC) chip comprising:
first circuitry to:
receive a first message which indicates a first address which corresponds to a first line of data; and
identify a first location of a preliminary cache based on the message;
second circuitry coupled to the first circuitry, wherein, based on the first message, the second circuitry is to:
identify a second location of a victim cache, comprising the second circuitry to perform a calculation based on one of an encryption key or a hash function;
move a second line from the first location to the second location; and
store the first line to the first location; and
a display device coupled to the IC chip, the display device to display an image based on a signal communicated with the IC chip.

17. The system of claim 16, wherein the second circuitry to identify the second location comprises the second circuitry to determine, based on the calculation, an index of a set of the victim cache.

18. The system of claim 16, wherein the primary cache comprises a skewed cache.

19. The system of claim 16, wherein the first circuitry is further to receive a second message which indicates a second address which corresponds to the second line; and
wherein the second circuitry is further to move the second line from the second location to the preliminary cache based on the second message.

20. The system of claim 19, wherein the second circuitry to move the second line from the second location to the preliminary cache comprises the second circuitry to swap the second line and a third line between the preliminary cache and the victim cache.
